(19) United States
(12) Patent Application Publication
(10) Pub. No.: US 2007/0106545 A1
(43) Pub. Date: May 10, 2007

(54) SYSTEM AND METHOD FOR RATE AND CAPACITY PLANNING

(75) Inventors: STEVEN JOWERS, Friendswood, TX (US); BARRY R. FOX, Ballwin, MO (US)

Correspondence Address: WILDMAN HARROLD ALLEN & DIXON LLP;AND THE BOEING COMPANY, 225 W. WACKER DR., CHICAGO, IL, 60606, US

(73) Assignee: THE BOEING COMPANY, Chicago, IL (US)

(21) Appl. No.: 11/557,011

(22) Filed: Nov. 6, 2006

Related U.S. Application Data
(60) Provisional application No. 60/734,905, filed on Nov. 8, 2005.

(51) Int. Cl. G06F 9/46

(52) U.S. Cl. 705/8

(57) ABSTRACT

The invention relates to methods for production rate and capacity planning used to answer key questions necessary for planning efficient production operations, where the goal is to plan the performance of some repetitive body of work subject to a combination of constraints on duration, rate, and resources. In one embodiment, resource quantity, unit duration, production interval, and/or resource utilization may be determined utilizing a method of applying derived equations.

### RELATED APPLICATIONS

This application is a utility application claiming priority to provisional U.S. application Ser. No. 60/734,905, titled System And Method For Rate And Capacity Planning, filed on Nov. 8, 2005.

### BACKGROUND OF THE INVENTION

Production rate and resource capacity planning may be described as an inter-related set of processes used to answer key questions necessary for planning efficient production operations, where the goal is to plan the performance of some repetitive body of work subject to a combination of constraints on duration, rate, and resources. This type of planning may be applicable to any operational context involving repetitive work which may result in the delivery of finished products or completed services, and/or applicable to other types of non-operation contexts. The following four basic questions may be asked in the context of Production Rate and Capacity Planning:
(Q1) What is the highest production rate that can be achieved with the available resources?
(Q2) What quantity of resources is required to achieve the target production rate?
(Q3) What is the shortest duration that can be achieved with the available resources?
(Q4) What quantity of resources is required to achieve the target duration?

Together, these questions (and other questions itemized in Section 6 of the Description below) may characterize the objectives of production rate and resource capacity planning.

In current practice, only one of these four questions, question Q3, may be easily answered, and only when a number of simplifying assumptions may be satisfied. The remainder of these questions often go unanswered, or are often answered only by ad-hoc, trial and error exercises. Using current practice there may be no assurance that suitable answers may be obtained or that the answers will prove valid in production operations. Often the most effective, but most expensive and time-consuming method used to answer these questions may be to implement a decision in production operations and to incrementally adjust resource quantities, target durations, and target rates until performance goals are achieved.

In current practice, questions Q1 and Q3 may be answered by constructing a finite capacity schedule for the planned work, limited by the fixed quantity of resources provided, using simulation or other conventional means. Each time a new quantity of resources is considered, the process may be repeated.

In current practice, questions Q2 and Q4 may not be so easily answered. For instance, often several different resource plans are constructed, and for each constructed resource plan a schedule may also be constructed (such as answers to question Q1 or Q3). If a schedule is produced that is near the target duration, small changes may be made to the corresponding resource plan and further trials may be run. Even when a suitable schedule is found, there may be no assurance that the best resource plan has been found because there may be so many ways that the quantity of required resources can be varied. Current practice often relies upon ad-hoc, trial and error exercises, and even when an answer is obtained, the quality of that answer may be uncertain.

One or more methods of production rate and resource capacity planning are needed to efficiently answer questions Q1, Q2, Q3, and/or Q4.

### SUMMARY OF THE INVENTION

In one aspect of the invention, a method for production rate and capacity planning is provided. In one step, a resource quantity, unit duration, and production interval is determined for Category 1 resources. Category 1 resources comprise resources that are not shared between production units, which effect concurrency between the production units, which have no effect on the unit duration, and which have no effect on degree of concurrency within the production units. In another step, a resource quantity and unit duration is determined for Category 2 resources. Category 2 resources comprise resources that are not shared between the production units, which do not effect the concurrency between the production units, and which effect the unit duration by enabling the concurrency within the production units. In an additional step, a resource utilization is determined for Category 1 and Category 2 resources.

In another aspect of the invention, a method is provided for determining resource quantity, unit duration, and production interval for Category 1 resources. In one step, a minimum acceptable quantity of Category 1 resources is determined using at least one of fixed and target values for unit duration and production interval. Category 1 resources comprise resources that are not shared between production units, which effect concurrency between the production units, which have no effect on the unit duration, and which have no effect on degree of concurrency within the production units. In another step, a maximum acceptable unit duration is determined using at least one of fixed and target values for quantity of Category 1 resources and production interval. In yet another step, a minimum acceptable production interval is determined using at least one of fixed and target values for quantity of Category 1 resources and unit duration.

In still another aspect of the invention, a method is provided for determining resource quantity and unit duration for Category 2 resources. In one step, coefficients of a Parametric Model of Unit Duration are determined. In another step, a minimum unit duration that can be achieved with a given quantity of dedicated resources is determined. In still another step, a quantity of dedicated resources required to achieve a given unit duration is determined. Category 2 resources comprise resources that are not shared between the production units, which do not effect the concurrency between the production units, and which effect the unit duration by enabling the concurrency within the production units.

In yet another aspect of the invention, a method is provided for determining resource utilization. In one step, a utilization of Category 1 resources is determined using known quantities for at least one of unit duration, production interval, and quantity of dedicated resources. Category 1 resources comprise resources that are not shared between production units, which effect concurrency between the production units, which have no effect on the unit duration, and which have no effect on degree of concurrency within the production units. In another step, a utilization of Category 2 resources is determined using known quantities for at least one of unit duration and quantity of dedicated resources. Category 2 resources comprise resources that are not shared between the production units, which do not effect the concurrency between the production units, and which effect the unit duration by enabling the concurrency within the production units.

These and other features, aspects and advantages of the present invention will become better understood with reference to the following drawings, description and claims.

### BRIEF DESCRIPTION OF THE DRAWINGS

FIG. 1 depicts a graph of Equation 2 under one embodiment of the invention;

FIG. 2 depicts a graph of Equation 1 under another embodiment of the invention;

FIG. 3 illustrates non-concurrent production of one embodiment under the invention;

FIG. 4 illustrates non-concurrent production of another embodiment under the invention;

FIG. 5 illustrates concurrent production of yet another embodiment under the invention;

FIG. 6 illustrates concurrent production of still another embodiment under the invention;

FIG. 7 illustrates the relationship between degree of production concurrency C, unit duration D, and production interval I as a family of equations under another embodiment of the invention;

FIG. 8 illustrates the relationship between the linear function C and the step function Kₘₐₓ under another embodiment of the invention;

FIG. 9 depicts a flow chart of Method 1 under another embodiment of the invention;

FIG. 10 depicts a flow chart of Method 2 under another embodiment of the invention;

FIG. 11 depicts a flow chart of Method 2.1 under another embodiment of the invention;

FIG. 12 depicts a flow chart of Method 2.2 under another embodiment of the invention;

FIG. 13 depicts a flow chart of Method 2.3 under another embodiment of the invention;

FIG. 14 depicts a flow chart of Method 3 under another embodiment of the invention;

FIG. 15 depicts a flow chart of Method 3.1 under another embodiment of the invention;

FIG. 16 depicts a flow chart of Method 3.2 under another embodiment of the invention;

FIG. 17 depicts a flow chart of Method 4 under another embodiment of the invention;

FIG. 18 depicts a flow chart of Method 4.1 under another embodiment of the invention;

FIG. 19 depicts a flow chart of Method 4.2 under another embodiment of the invention;

FIG. 20 depicts a flow chart of Method 5 under another embodiment of the invention;

FIG. 21 depicts a flow chart of Method 6 under another embodiment of the invention;

FIG. 22 depicts a flow chart of Method 7 under another embodiment of the invention;

FIG. 23 is a table of data for demonstrating an example of one embodiment under the invention;

FIG. 24 is a table showing tabulations of resource quantity and resulting unit duration under one embodiment of the invention;

FIG. 25 is a table showing determined coefficients of the Parametric Model of Unit Duration under one embodiment of the invention; and

FIG. 26 is a graph, under one embodiment of the invention, showing the functional relationship between the quantity of Category 2 resources provided and the resulting unit duration as determined by the Parametric Model of Unit Duration, with an overlay of the empirical data from the Table of FIG. 24.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

### Section 1: Introduction

In one embodiment, a method for production rate and resource capacity planning is disclosed which may be applied in any context where the goal is to plan the performance of some repetitive body of work subject to a combination of constraints on duration, rate, and resources.

The instant invention may be applicable to any operational context involving repetitive work which may result in the delivery of finished products or completed services. The invention may be applicable to manufacturing (both fabrication and assembly), maintenance repair and overhaul, training, flight operations, and other contexts which entail the repetitive performance of work.

The invention may be used to make decisions in staffing, asset management, capital investment, production rates, supply contracts, sales, and others areas where it is necessary to determine the quantity of resources required to meet a target duration or rate, or where it is necessary to determine what duration or rate may be achieved with the available resources.

### Section 2: Production Rate and Resource Capacity Planning

### Section 2.1: General Information Regarding The Invention

Using one or more methods of the below disclosed invention, a single specific resource plan may be constructed. A set of derivative resource plans may be created and schedules may be constructed for each. The durations of these schedules may be analyzed and the results may be converted to an equational form and to an equivalent inverse form. Thereafter, any instance of questions Q1, Q2, Q3, and/or Q4 (as disclosed in the background section) for this body of work may be answered by application of the derived equation or its equivalent inverse form, without need to construct additional schedules. In many cases, this process may yield consistent, high quality answers based upon analysis of only three schedules.

In one embodiment of the invention, structured, systematic methods are provided to answer questions Q1, Q2, Q3, and/or Q4 (and others central to the processes of production rate and resource capacity planning). A discussion of key concepts and mathematical relationships is provided in this specification in order for the reader to understand the methods of the invention. The instant invention may unify the collection of processes required to perform production rate and capacity planning into a single decision process, which may contain the computational steps necessary for planning efficient production operations.

### Section 2.3: Methods Of Invention

The instant invention discloses multiple method embodiments which allows one of ordinary skill in the art to practice one or more of the following:
a parametric model of production concurrency;
a parametric model of unit duration;
a parametric model of resource availability;
a structured, systematic approach to production rate and resource capacity planning (See Section 7.1, Method 1);
a systematic approach for balancing resource capacity, unit duration, and production interval (See Section 7.2, Method 2);
a systematic approach for balancing resource capacity and unit duration (Section 7.3, Method 3);
a systematic approach for constructing a parametric model of unit duration (Section 7.4, Method 4);
a systematic approach for constructing a parametric set of resource plans (Section 7.5, Method 5);
a systematic approach for estimating net resource utilization in the context of specific production rates, unit durations, and resource capacities (Section 7.6, Method 6);

### Section 3: Mathematical Background

Several of the mathematical relationships that may occur in the study of schedules and scheduling may have a common mathematical representation. These may include, but may not be limited to the following: the relationship between work content, duration, and resource quantity; the relationship between degree of concurrency, unit duration, and production interval; the relationship between resource capacity and unit duration; and the relationship between resource capacity and production rate.

To avoid redundantly presenting and deriving some of the key equational forms, the following basic discussion will be presented once, and then referenced as appropriate.

### Section 3.1: Basic Equations of the Common Mathematical Relationship

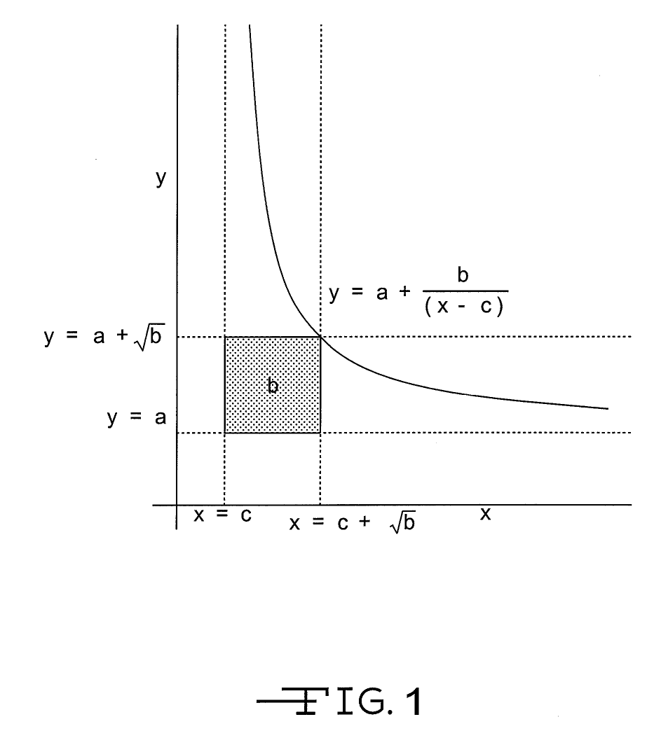

Several of the mathematical relationships that may occur in the study of schedules and scheduling may be characterized as a common mathematical relationship illustrated in FIG. 1. The simplest form is a basic equation of two variables x and y as follows:

$$y = \frac{1}{x} \qquad Eq . 1$$

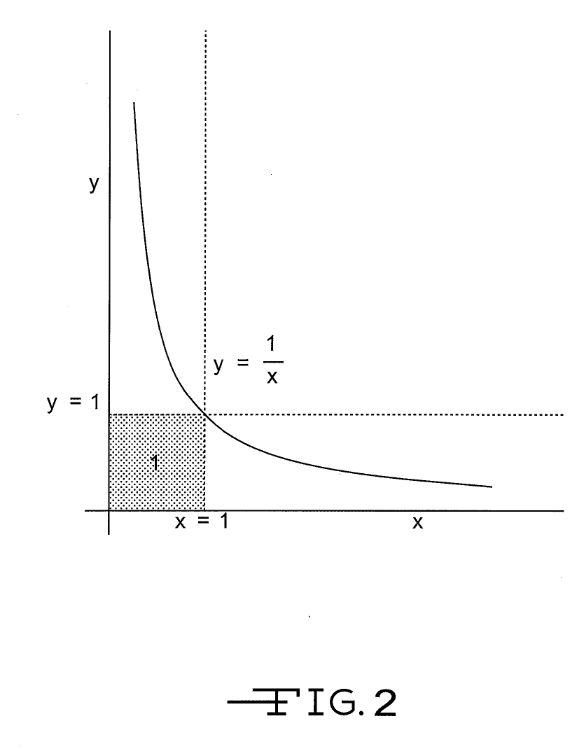

The graph for Eq. 1 is asymptotic to the lines x=0 and y=0, and may contain the point x=1, y=1 as illustrated in FIG. 2.

The simple relationship between two variables x and y may be further generalized by an equation of the form (including its various equivalent forms):

$$y = a + \frac{b}{( x - c )} \qquad Eq . 2$$

The graph for Eq. 2 may be asymptotic to the lines x=c and y=a, and may contain the point
(x=c+\sqrt{b}y=a+\sqrt{b})
The coefficients a, b, and c may influence the shape and placement of the graph as illustrated in FIG. 1.

### Section 3.2: Estimating Coefficients from Empirical Data

Estimating the coefficients a, b, and c in Eq. 2 from empirical data may be based upon the assumption that the basic relationship defined in Eq. 1 may hold between the two variables x and y as modified by the additional parameters a, b, and c in Eq. 2. The simplest method for computing these coefficients may use two selected data points and may determine values for the coefficients which yield an equation going through those points. Other methods may analyze all data points and may determine values for the coefficients which may yield an equation which is the best fit to the data points using distance measures such as least squares.

In order to provide a suitably complete presentation of a method for production rate and resource capacity planning the following mathematical analysis derives a simple method which may determine values for the coefficients using two selected data points. Equivalent and related methods may be obtained from standard mathematics, statistics, or engineering textbooks and will not be presented here.

For purposes of the analysis, assume that two data points x₁, y₁, and x₂, y₂ are given, and that they each lie on the line defined by Eq 2. Also assume that these equations are used in a context where the value of coefficient a can be estimated or determined independently. This assumption may be satisfied in the methods described below.

The value of c may be determined by first incorporating known values for two data points x₁, y₁ and x₂, y₂, inserting the coefficient a into the equations, and rewriting the equations through a series of steps comprising the following:

$$\begin{matrix}{y}_{1} = a + \frac{b}{( {x}_{1} - c )} and {y}_{2} = a + \frac{b}{( {x}_{2} - c )} & Eq . 3.1 \\ ( {y}_{1} - a ) \cdot ( {x}_{1} - c ) = b and ( {y}_{2} - a ) \cdot ( {x}_{2} - c ) = b & Eq . 3.2 \\ ( {y}_{1} - a ) \cdot ( {x}_{1} - c ) = ( {y}_{2} - a ) \cdot ( {x}_{2} - c ) & Eq . 3.3 \\ \frac{( {y}_{1} - a )}{( {y}_{2} - a )} = \frac{( {x}_{2} - c )}{( {x}_{1} - c )} & Eq . 3.4\end{matrix}$$

To simplify the necessary computations the following substitution may be introduced:

$$k = \frac{( {y}_{1} - a )}{( {y}_{2} - a )} \qquad Eq . 3.5$$

Eq. 3.4 may be rewritten as follows:

$$\begin{matrix}k = \frac{( {x}_{2} - c )}{( {x}_{1} - c )} & Eq . 3.6 \\ k \cdot ( {x}_{1} - c ) = ( {x}_{2} - c ) & Eq . 3.7 \\ k \cdot {x}_{1} - k \cdot c = {x}_{2} - c & Eq . 3.8 \\ k \cdot {x}_{1} - {x}_{2} = k \cdot c - c & Eq . 3.9 \\ k \cdot {x}_{1} - {x}_{2} = ( k - 1 ) \cdot c & Eq . 3.10\end{matrix}$$

This may yield the following equation for the coefficient c:

$$c = \frac{( k \cdot {x}_{1} - {x}_{2} )}{( k - 1 )} \qquad Eq . 3.11$$

Using either part of Eq. 3.1, the value for coefficient b may be determined by incorporating known values for one data point, (e.g. x₁,y₁), inserting the coefficients a and c into the equations, and rewriting the equations through the following steps:

$$\begin{matrix}{y}_{1} = a + \frac{b}{( {x}_{1} - c )} & Eq . 3.12 \\ {y}_{1} - a = \frac{b}{( {x}_{1} - c )} & Eq . 3.13\end{matrix}$$

This may yield the following equation for the coefficient b:
b=(y₁−a)·(x₁c) Eq. 3.14

### 3.3 Derivation of the Equivalent Inverse Equation

Using similar analysis, an equation that determines the value of x, given the value for y, and the coefficients a, b, and c, may be derived by the following transformations:

$$\begin{matrix}y = a + \frac{b}{( x - c )} & Eq . 4.1 \\ y - a = \frac{b}{( x - c )} & Eq . 4.2 \\ ( y - a ) \cdot ( x - c ) = b & Eq . 4.3 \\ ( y - a ) \cdot x - ( y - a ) \cdot c = b & Eq . 4.4 \\ ( y - a ) \cdot x = ( y - a ) \cdot c + b & Eq . 4.5\end{matrix}$$

This may yield the following equation for the variable x as a function of y:

$$x = \frac{( y - a ) \cdot c + b}{( y - a )} \qquad Eq . 4.6$$

### Section 4: Concepts and Definitions

The instant disclosure includes the following inter-related set of concepts, definitions, and formulae that together provide necessary background for a complete description of the method for production rate and resource capacity planning:

Concepts of Production (Section 4.1);

Concepts and Measures of Resources (Section 4.2);

Concepts and Measures of Work (Section 4.3);

Concepts and Measures of Production Rate (Section 4.4);

Concepts and Measures of Concurrency (Section 4.5); and

Concepts and Measures of Duration (Section 4.6).

### Section 4.1: Concept of Production

In the context of production rate and resource capacity planning, the concept of production may be defined to be delivery of a finished product or completed service. The delivery of a single instance of a product or service may constitute a single production unit, while the delivery of multiple similar instances of a product or service may constitute repetitive production.

### Section 4.2: Concepts and Measures of Resources

### Section 4.2.1: Resource

A resource may be defined as any physical asset required for production, or as defined below, any physical asset required for the performance of work.

### Section 4.2.2: Provisioning of Resources

### Section 4.2.2.1: Fixed Resources

In any given production context there may be some resources that are limited and fixed in quantity. Because the performance of work depends upon the availability of necessary resources, any resources that are limited and fixed in quantity may, in turn, constrain or limit the performance in work and its associated duration and rate.

### Section 4.2.2.2: Flexible Resources

In any given production context there may be some resources that are flexible where the quantity available may be increased or decreased to satisfy production demands, cost of operation, and other factors. Because the performance of work may depend upon the availability of necessary resources, any resources that are flexible, may be adjusted to enable the performance of work and its associated duration, and rate.

### Section 4.2.3: Allocation and Usage of Resources

### Section 4.2.3.1: Dedicated Resources

Dedicated resources may be those that are assigned to a single production unit, from start until finish, without being assigned or applied to any other concurrent production unit. When one production unit is complete, dedicated resources may be assigned to a successive production unit, again dedicated from start until finish.

An example of a dedicated resource may be a pilot assigned to an aircraft to fly a commercial flight. Clearly, a pilot cannot time-share between two aircraft. A pilot may be dedicated to one aircraft and one flight from start until finish and when that flight is complete, may be assigned to another aircraft.

### Section 4.2.3.2: Shared Resources

Shared resources may be those that are assigned to concurrent production units. During the period of time in which the concurrent production units are in work, shared resources may be alternately applied to one production unit, then to another, or to both simultaneously. When one production unit is complete, shared resources may be assigned to a successive production unit, while continuing to support those that have not yet been completed.

If a resource is or can be used to support more than one concurrent production unit at the very same moment of time, that usage may be said to be simultaneous. If a resource is or can be used to support more than one concurrent production unit by successively switching between them, that usage may be said to be interleaved.

An example of a shared resource and simultaneous usage may be an auxiliary power unit that can concurrently supply electricity to multiple pieces of equipment, up to the limit of its power rating and the availability of power connectors. Another example of a shared resource may be an instructor in a lab concurrently assisting multiple students, where general assistance may be simultaneous (advice or instructions to more than one student) and specific assistance may be interleaved (advice or instruction to only one student at a time).

### Section 4.2.3.3: Dedicated and Shared Resources Assigned in the Same Context

Both dedicated and shared resources may be utilized in the same context of work. For example, a maintenance crew may be assigned to a flight line expected to support multiple aircraft at one time. Upon landing, an aircraft may be assigned a fixed gate (as a dedicated resource) until departure, while the crew (as a shared resource) may be expected to divide its support among all aircraft on the ground. While it may be feasible to assign a fixed crew to each gate as a dedicated resource, assigning a fixed crew at each gate of sufficient size to address all possible maintenance requirements may be excessive. At the same time, assigning a smaller crew at each gate may create risks that one aircraft may be delayed because of greater than average maintenance requirements while crew at another gate may be underutilized. Using a maintenance crew as a shared resource may require fewer total individuals while providing sufficient capacity to respond to variation in maintenance requirements on a case-by-case basis.

### Section 4.2.4: Resource Usage and Effects

There are four basic effects that activities may have on resources. Two effects may be temporary. For instance, an activity may reserve and use a resource for a finite period of time (precluding use by other activities), or an activity may provide and make available a resource for a finite period of time (enabling use by this same or other activities). Two other effects may be permanent. For instance, an activity may consume a resource and permanently decrease the quantity available (preventing further use by any activity), or an activity may produce a resource and permanently increase the quantity available (enabling use by this same or subsequent activities).

This discussion of production rate and resource capacity planning may be concerned primarily with temporary reservation and use of resources over finite periods of time. The mathematics which relate the quantity of reserved resources to the overall rate of production for a given product or service may not be immediately obvious, yet when applied correctly may be powerful.

The occurrence of activities that provide resources over finite periods of time may be exceptional, and will be excluded from further discussion, although the mathematical models provided below may, to a certain extent, be equally applied to this category of usage and effects.

The mathematics which relates the quantity of resources permanently consumed or produced to the overall rate of production for a given finished product or completed service may be comparatively simple, and intuitive, and will be excluded from further discussion.

### Section 4.2.5: Concepts and Measures of Resource Quantity

### Section 4.2.5.1: Dimensions of Resource Usage

Focusing on temporary reservation and use of resources over finite periods of time, resource reservation and use may have two dimensions: (1) the quantity, and (2) the duration of time that the resource is required or provided.

### Section 4.2.5.2: Units of Resource Quantity

The quantity of a resource, required or provided for the performance of some body of work, may be measured in some units such as: number of individuals; watts of electricity; number of tools; fixtures; or jigs, etc. Some measures of quantity may be clearly quantized such as number of tools or individuals, while other quantities may have a finer granularity such as watts of electricity that may be measured in both whole units and fractional parts.

### Section 4.2.5.3: Representation of Resource Quantity

In general, the quantity of resources required or provided for the performance of work (over a suitable period of time) may be represented by a vector, where each element of the vector may represent the quantity of resources required or provided within a single, distinct resource category. Systematic analysis of how the quantity of resources provided affects unit duration or production interval may require systematic exploration of the entire multidimensional vector space.

Such analysis may be simplified by focusing on a parametric model of resource availability defined using a proportional resource vector and a parametric series of quantized resource vectors (both are defined below). The basis for this concept may be simple but may require reflection on how resource availability affects unit duration (and equivalently production interval).

If only one category of resource is required for completion of one production unit, it may be reasonable to assume that the unit duration will be affected by the quantity of that resource. If only a small quantity is provided, the duration may be long. If a larger quantity is provided, the duration may be shorter. After a certain point, increase in the quantity provided may produce no further decrease in unit duration (see discussion of Minimum Duration and Resource Dependent Duration provided below).

If two categories of resources are required for completion of one production unit, it may also be reasonable to assume that the unit duration will be affected by the separate quantities of the resources provided. If a small quantity of the first resource is provided and a very large quantity of the second resource is provided, then the quantity of the first resource may have the most effect and the duration may be long. Likewise, if a very large quantity of the first resource is provided and a small quantity of the second resource is provided, then the quantity of the second resource may have the most effect and the duration, again, may be long. Separately exercising the quantity of each resource across a range of values may be wasted effort because the result may be largely determined by the resource that has the smallest proportional value.

The alternative may be to exercise the quantity of resources through a series of cases. In each case, the quantity of each resource may have an equal and balanced effect on unit duration. Analysis of the effect of resource availability on unit duration and production interval may require three things. First, it may require a means for determining the correct proportion between resources so that each resource has an equal and balanced effect. Second, it may require some means to represent that proportion. Third, it may require some means to construct a parametric series of individual cases, which may vary across a range of values while still preserving the desired proportions.

As will be described below, the correct proportion between resources may be derived from the Basis Work Content Vector. Construction of the parametric model of resource availability and resource vectors for individual cases of the analysis may begin with construction of a Proportional Resource Vector and may follow with construction of a parametric series of Quantized Resource Vectors.

### Section 4.2.5.3.1: Resource Vector

In general, large complex bodies of work may require a mixture of differentiated resources in their performance, and even individual tasks may require resources from two or more distinct resource categories. The resources may include specific tools, pieces of equipment, human labor categorized by skill (e.g. electrician or mechanic) or qualification, and fluid resources of finer granularity such as electricity or thermal capacity.

In general, the quantity of resources required or provided for the performance of work (over a suitable period of time) may be represented by a vector where each element of the vector may represent the quantity of resources required or provided within a single, distinct resource category. Where useful or necessary, the quantity of resources provided for the performance of work may be divided into two or more vectors representing the separate allocation of shared and dedicated resources as follows:
R=[r_{1,}r₂, . . . rₘ], where Eq. 5.1
rⱼ=the quantity of resource category j required or provided Eq. 5.2

### Section 4.2.5.3.2: Total Quantity

The total quantity of resources T required or provided for the performance of some activity or body of work may, in some cases, be usefully computed as the sum of the elements within a Resource Vector. For example, this may be useful when considering the total number of individuals within a mixed pool of labor divided between specific skill sets. This quantity may also be useful in the definition of other concepts such as a Proportional Resource Vector.

$$T = {\sum }_{j = 1}^{m} {r}_{j} \qquad Eq . 6$$

### Section 4.2.5.3.3: Proportional Resource Vector

A Proportional Resource Vector may be defined to be a resource vector where each element represents the percentage of the total resources contained within the corresponding resource category. By definition, this may imply that the sum of all elements within a Proportional Resource Vector equals one.

$$\begin{matrix}P = [ {p}_{1 ,} {p}_{2} , … {p}_{m} ] , and & Eq . 7.1 \\ {\sum }_{j = 1}^{m} {p}_{j} = 1 & Eq . 7.2\end{matrix}$$

Clearly, any resource vector (R) may be reduced to a proportional resource vector (P) by dividing each element of (R) by (T).

$$P = [ \frac{{r}_{1}}{T ,} \frac{{r}_{2}}{T} , … \frac{{r}_{m}}{T} ] \qquad Eq . 8$$

### Section 4.2.5.3.4: Quantized Resource Vector

A Quantized Resource Vector (Pₛ) may be defined to be a proportional resource vector (P) multiplied by a scalar quantity (s) as defined in the following:
Pₛ=s·P=[s·p_{1,}s·p₂, . . . s·pₘ], where (s) is a scalar value and Eq. 9.1
P=[p_{1,}p₂, . . . pₘ] is a proportional resource vector. Eq. 9.2

### Section 4.2.5.3.5: Parametric Series of Quantized Resource Vectors

A Parametric Series of Quantized Resource Vectors may be defined to be a set of resource vectors:
P₁,P₂, . . . Pₙ Eq. 10
wherein each Quantized Resource Vector (Pᵢ) may be constructed from a common Proportional Resource Vector (P), and scalar values s=1, 2, 3, . . . n.

### Section 4.2.5.3.6: Modified Resource Vector

A Modified Resource may be defined as a quantized proportional resource vector where the quantity of resources in each category has been rounded up and modified as necessary to satisfy the minimum resource requirements for performance of the given activity or production unit.
U=[u_{1,}u₂, . . . uₘ], where Eq. 11.1
R=[r_{1,}r₂, . . . rₘ] is a quantized proportional resource vector and Eq. 11.2
uᵢ=[rᵢ], where use of [ ] indicates rounded and modified as necessary. Eq. 11.3

### Section 4.2.5.3.7: Scalar Representation of Resource Quantity

The mathematical relationship between resource quantity and unit duration, and the mathematical relationship between resource quantity and production interval, may be reduced to a common mathematical relationship as discussed in multiple sections below. Derivation and use of these mathematical relationships may depend upon a means to represent the quantity of resources required or provided as single scalar value. Clearly, the total quantity of resources, computed as the sum of elements within a resource vector, may be a candidate. Without additional restrictions this may be a poor choice. Many different resources vectors may yield the same total quantity of resources yet yield different unit durations or production intervals when used to generate schedules.

The mathematical relationship may depend upon more than total quantity. The mathematical relationship may be best derived and may be best employed in the context of a family of resource vectors where all resource vectors in the family can be reduced to one common proportional resource vector, and where each element of each resource vector has an equal and balanced effect on unit duration or production interval. Construction of a suitable family of resource vectors, based upon analysis of total work content, is described below.

Within a suitably constructed family of resource vectors, each resource vector (R) may be equivalent to a common proportional resource vector (P), multiplied by some scalar value (S).
R=S·P=[S·p_{1,}S·p₂, . . . S·pₘ], where (S) is a scalar value. Eq. 12.1
As a result, the total quantity of resources may equal (S):

$$S = {\sum }_{j = 1}^{m} {r}_{j} = {\sum }_{j = 1}^{m} S \cdot {p}_{j} = S \cdot {\sum }_{j = 1}^{m} {p}_{j} = S \cdot 1 \qquad Eq . 12.2$$

Restricting focus to a suitable family of resource vectors, the total quantity of resources, or equivalently the scalar multiplier of the proportional resource vector, may serve as a suitable scalar representation of resource quantity and basis for deriving the desired mathematical relationships.

In practice, schedules may be constructed only from resource vectors that have been modified to satisfy the minimum resource requirements for performance of the given production unit. In practice then, the total quantity of resources within the quantized resource vector may be less than the total quantity of resources within the modified resource vector. Experience may show that either may be used within the methods described below, but use of the total quantity of resources within the modified resource vector may yield slightly more accurate results.

In the remainder of this application, the variable Q will be used to denote the quantity of resources required or provided for the performance of work. In all contexts, it is assumed that Q represents the total quantity of resources contained within a modified resource vector within a suitable family of resource vectors with a common proportional basis.

### Section 4.3: Concepts and Measures of Work

It may be impossible to provide a single definition of work that will serve equally in all contexts for production rate and resource capacity planning. Nevertheless, for this discussion, work may be defined to be performance of a set of activities, making use of a set of resources, contributing to the delivery of a finished product or completed service.

For example, the activity of manufacturing and assembling component parts to create a finished product qualifies as work. In maintenance, the activity of removing a failed component and replacing it with a new component to restore a product to an operational condition qualifies as work. Less obvious, the activity of inspecting aircraft structure to ensure that no fatigue or corrosion is present qualifies as work. In teaching, the activity of creating, delivering, and grading a test to certify the capabilities of the students qualifies as work.

Other examples are less clear but still qualify as work. For example, baking carbon-fiber epoxy composite materials in an oven to cure the plastics and bond the materials adds value to the finished product but does not immediately appear to be an activity. Other examples include processes of annealing, tempering, fermentation, drying, and curing which do not immediately appear to be activities yet all add value to manufactured goods.

Some might argue that activities or periods of time that do not add value to a product or service should not be interpreted as work. Nevertheless, activities or periods of time that require resources (for storage, for example) are relevant to this discussion and there will be no attempt in the following to distinguish between value-added and non-value-added activities, resource assignments, or periods of time.

Repetitive work may be accomplished by repetitive performance of a set of activities, making use of a set of resources, resulting in the delivery of multiple units of a finished product or completed service.

### Section 4.3.1: Work Content of One Activity

By convention, the work content of one activity may be defined as the product obtained by multiplying the quantity of resources required to perform the activity by the duration of the activity, each measured in relevant units. The most common measure of work content may be man-hours, or equivalently labor-hours, used in those cases where people may be required for the performance of work. Equally common may be references to man-months or man-years. This definition of work content may apply whether or not the resources are flexible and whether or not the duration is resource dependent.

Given a duration d, and a quantity of undifferentiated resources q, the work content w of one activity may be defined by the three equivalent equations (instances of the common mathematical relation defined by Eq 1) as follows:

$$\begin{matrix}d = \frac{w}{q} & Eq . 13.1 \\ q = \frac{w}{d} & Eq . 13.2 \\ w = q \cdot d & Eq . 13.3\end{matrix}$$

### Section 4.3.2: Work Content of One Production Unit

When the work required to complete one production unit may be accomplished by performing a collection of individual activities by a pool of undifferentiated resources, the work content w may be defined as the sum of the work content of n individual activities as follows:

$$\begin{matrix}w = {\sum }_{i = 1}^{n} {q}_{i} \cdot {d}_{i} , where & Eq . 13.1 \\ {q}_{i} = the quamtity of resources required for task i , \\ and & Eq . 14.2 \\ {d}_{i} = duration of task i & Eq . 14.3\end{matrix}$$

### Section 4.3.3: Work Content Using a Vector of Resources

In general, large complex bodies of work may require a mixture of differentiated resources in their performance, and even individual tasks may require resources from two or more distinct resource categories. The resources may include specific tools, pieces of equipment, and human labor categorized by skill (e.g. electrician or mechanic) or qualification.

In general, the quantity of resources required for the performance of work may be represented by vector where each element of the vector may represent the quantity of resources required within a single, distinct resource category. In some cases, the quantity of resources required for the performance of work may be divided into two or more vectors representing the separate allocation of shared and dedicated resources.

### Section 4.3.3.1: Basis Work Content Vector

The Basis Work Content Vector (W_{basis}) for one production unit may be defined to be a vector where each element represents the work content within the corresponding resource category as follows:

$$\begin{matrix}{W}_{basis} = [ {w}_{1 ,} {w}_{2} , … {w}_{m} ] , where & Eq . 15.1 \\ {w}_{j} = {\sum }_{i = 1}^{n} {q}_{i}^{j} \cdot {d}_{i} , and & Eq . 15.2 \\ {q}_{i}^{j} = the quantity of resource category j required for task i & Eq . 15.3\end{matrix}$$

### Section 4.3.3.2: Exclusions from the Basis Work Content Vector

Given this definition, the Basis Work Content Vector (W_{basis}) may contain only those resources which are directly associated with the performance of individual activities (Eq 15.2 & Eq 15.3). It may not contain and may not account for the quantity of resources associated with the completion of one production unit as a whole (rather than completion of individual tasks).

For example, completion of a major assembly may require the performance of hundreds of individual tasks by individuals within specific labor categories and each task may explicitly require other supporting resources (such as test equipment, cranes, or hand tools). These requirements may be contained within the Basis Work Content Vector.

At the same time, this assembly may require dedicated use of an assembly jig for the full duration of work performed by those individuals. There may be no basis for computing the work content associated with the assembly jig as the product of a quantity and duration. While the quantity required may be easily stated (quantity one) the duration required may depend entirely upon quantity of other resources provided and the way that the work is organized and managed. Simple application of Eq 15.2 may lead to an equally questionable result. If use of the jig is associated with every constituent task then the work content computed for the jig may be equal to one times the sum of all task durations. This value may have reasonable interpretation if the tasks are performed serially, one after the other (one jig multiplied by the net duration), but may have no reasonable interpretation when the tasks are organized and managed to be performed with some degree of concurrency or a parallelism (the real requirement for the jig will then be one jig multiplied by the resulting duration). (See also discussion of Resource Requirements, Allocation, and Usage).

### Section 4.3.3.3: Total Work Content

The total work content W for one production unit may be computed as the sum of the elements within the Basis Work Content Vector as follows:

$$W = {\sum }_{j = 1}^{m} {w}_{j} \qquad Eq . 16$$

### Section 4.3.3.4: Proportional Work Content Vector

The Proportional Work Content Vector V for one production unit may be defined to be a vector, where each element represents the percentage of the total work content contained within the corresponding resource category (computed by dividing each element of the basis work content vector by the total work content (W) (Eq. 16)) as follows:

$$\begin{matrix}V = [ {v}_{1 ,} {v}_{2} , … {v}_{m} ] , where & Eq . 17.1 \\ {v}_{j} = \frac{{w}_{j}}{W} & Eq . 17.2\end{matrix}$$

In later discussion of the detailed methods for production rate and capacity planning, the Proportional Work Content vector may be used to derive a Proportional Resource Vector and a Parametric Series of Resource Vectors.

### Section 4.4: Concepts and Measures of Production Rate

### Section 4.4.1: Interval Between Start

The interval between start of production units, in the performance of repetitive work, may be the duration of time between start of successive production units.

### Section 4.4.2: Interval Between Finish

The interval between finish of production units, in the performance of repetitive work, may be the duration of time between finish of success production units.

### Section 4.4.3: Production Interval (I)

The production interval I, in the performance of repetitive work, may be synonymous with the interval between finish. In a steady state condition for production, the interval between start and the interval between finish may be constant and equal and may be used synonymously with production interval.

Production interval may be further qualified with key words and phrases such as actual production interval, target production interval, minimum production interval, maximum production interval, etc. that may be defined separately, as necessary.

### Section 4.4.4: Production rate (R)

The production rate R, in the performance of repetitive work, may be the ratio between the number of finished production units and the duration of time required for their completion. Production rate may be further qualified with key words and phrases such as actual production rate, target production rate, minimum production rate, and maximum production rate, that will be defined separately, as necessary.

In practice, the word rate may be most commonly used in discussions of production but it is sometimes problematic to represent rate as a useful ratio. To be useful, the timeframe for this ratio should be long enough to contain at least one completed production unit and preferably several. Moreover, production rate may have many equivalent forms that can only be compared by conversion to a common denominator (e.g. 1 unit per month is equivalent to 12 units per year). Worse, common time units may have inconsistent boundaries leading to mathematical discrepancies (4 units per month is equivalent to 48 units per year, but 1 unit per week is equivalent to 52 units per year).

Within this methodology and its associated equations and algorithms, production interval I may be a more useful parameter and will be used most often.

### Section 4.4.5: Relationship between Production Interval (I) and Production Rate (R)

Given the previous definitions of production interval I and production rate R, the relationship between production interval I and production rate R may be given by three equivalent equations (instances of the common mathematical relation defined by Eq. 1) as follows:

$$\begin{matrix}R = \frac{1}{I} & Eq . 18.1 \\ I = \frac{1}{R} & Eq . 18.2 \\ I \cdot R = 1 & Eq . 18.3\end{matrix}$$

### Section 4.5: Concepts and Measures of Concurrency

### Section 4.5.1: Concept of Concurrent Production

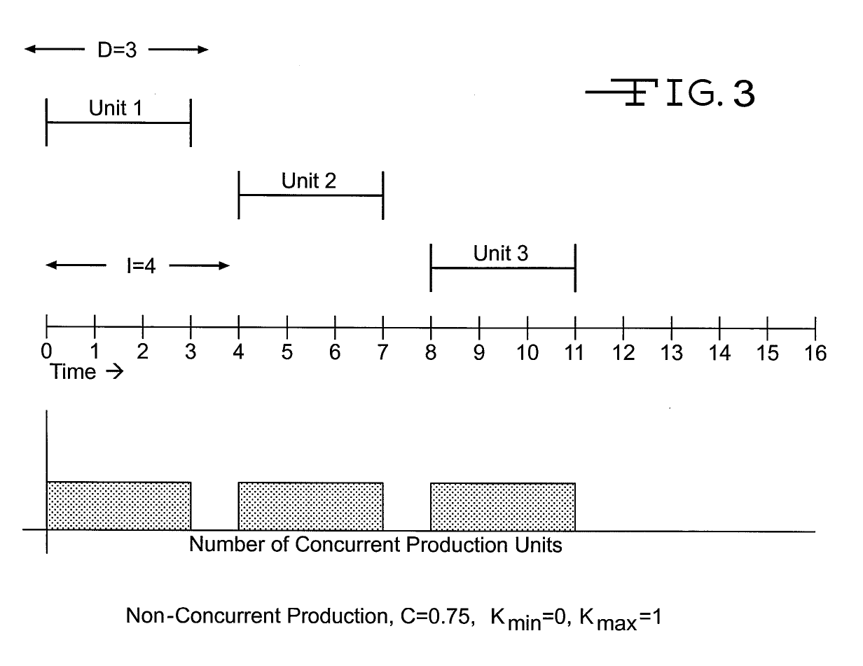

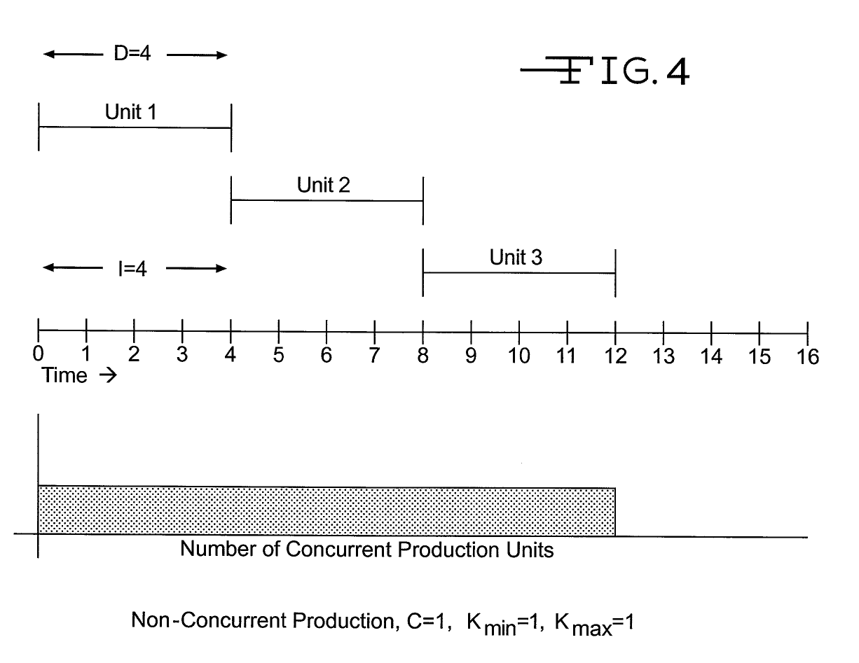

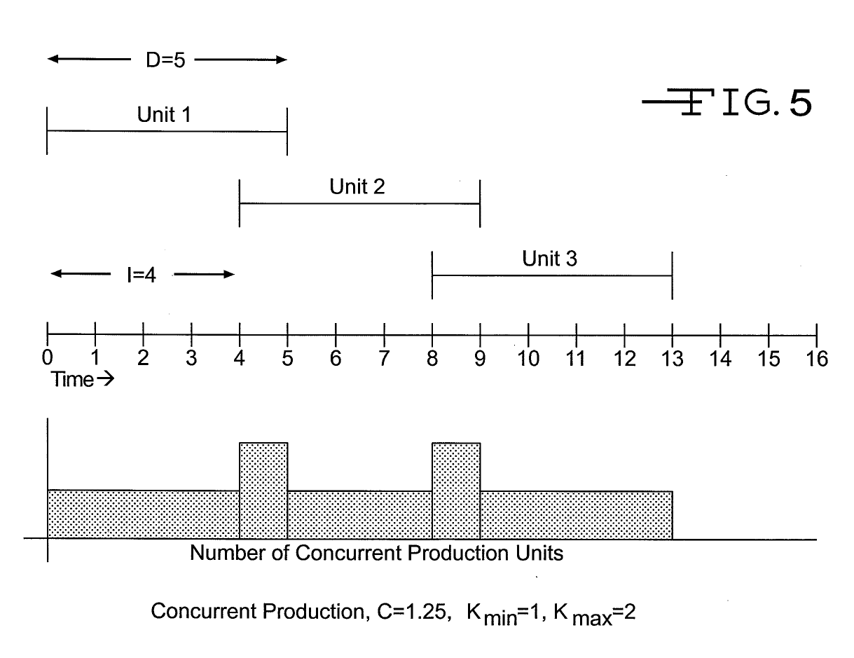

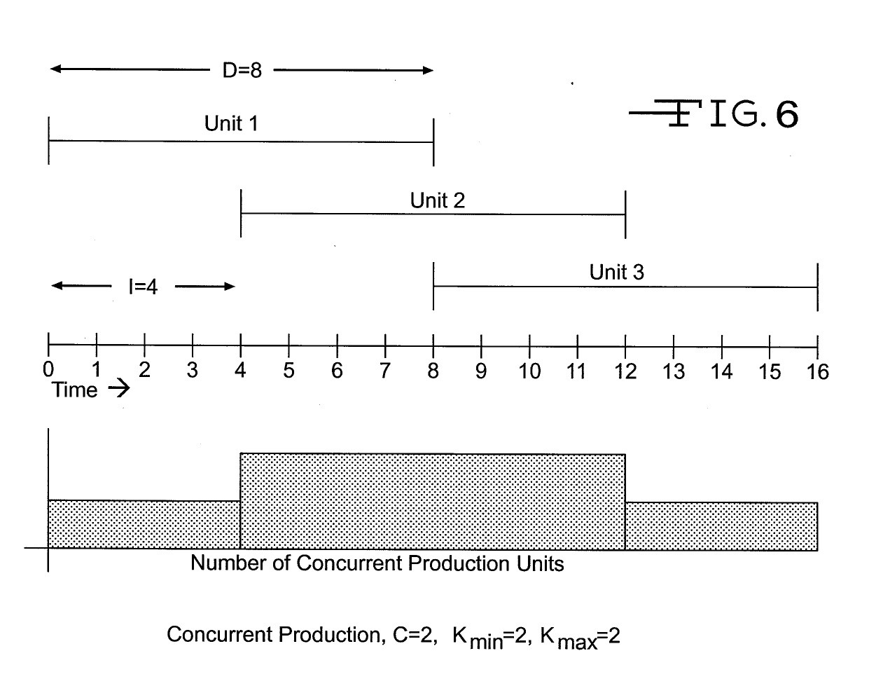

Concurrent production may occur when, during the performance of repetitive work, two or more production units are simultaneously in work for some measurable period of time in their performance. In the following discussion, FIG. 3 and FIG. 4 illustrate non-concurrent production, while FIG. 5 and FIG. 6 illustrate concurrent production.

### Section 4.5.2: Degree of Production Concurrency (C)

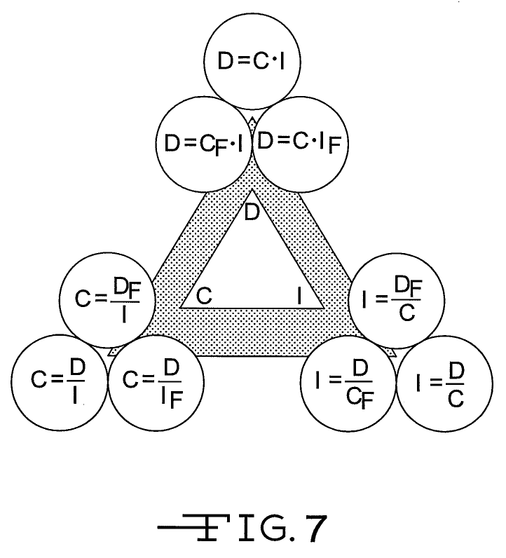

The degree of concurrency, within the performance of repetitive work, may be the measure of how much of the work is performed concurrently. FIGS. 3, 4, 5, and 6 illustrate the concept of production concurrency while FIG. 7 illustrates the relationship between degree of production concurrency C, unit duration D, and production interval I as a family of equations as defined below.

### Section 4.5.2.1: Relationship between Degree of Production Concurrency (C), Unit Duration (D), and Production Interval (I)

Given the previous definitions of unit duration D, production interval I, and degree of concurrency C, the Parametric Model of Production Concurrency may be given by following three equivalent equations (instances of the common mathematical relation defined by Eq. 1):

$$\begin{matrix}C = \frac{D}{I} & Eq . 19.1 \\ I = \frac{D}{C} & Eq . 19.2 \\ D = C \cdot I & Eq . 19.3\end{matrix}$$

### Section 4.5.2.2: Derivative Forms

The derivative forms of Eq. 19 may form a family of equations, as shown in FIG. 7, that can be used in a variety of circumstances. When values of both D and I are known, Eq. 19.1 may be used to compute the value of C. Moreover, if only D is known or I is known, this equation may define the functional relationship between C and the remaining free variable, as shown in the following derivative equations where D_{F} and I_{F} are known fixed values.

$$\begin{matrix}C = \frac{{D}_{F}}{I} & Eq . 19.1 a \\ C = \frac{D}{{I}_{F}} & Eq . 19.1 b\end{matrix}$$

When values of both D and C are known, Eq. 19.2 may be used to compute the value of I. Moreover, if only D is known or C is known, this equation may define the functional relationship between I and the remaining free variable, as shown in the following derivative equations where D_{F} and C_{F} are known fixed values.

$$\begin{matrix}I = \frac{{D}_{F}}{C} & Eq . 19.2 a \\ I = \frac{D}{{C}_{F}} & Eq . 19.2 b\end{matrix}$$

When values of both I and C are known, Eq. 19.3 may be used to compute the value of D. Moreover, if only D is known or C is known, this equation may define the functional relationship between I and the remaining free variable, as shown in the following derivative equations where I_{F} and C_{F} are known fixed values.
D=C_{F}·I Eq. 19.3a
D=C·I_{F} Eq. 19.3b

### Section 4.5.3: Degree of Maximum and Minimum Production Concurrency (Kₘₐₓ and Kₘᵢₙ)

Given the previous definition of degree of production concurrency C, the degree of maximum production concurrency Kₘₐₓ and the corresponding degree of minimum production concurrency, Kₘᵢₙ may be defined by the following.
Kₘₐₓ=┌C┐, defined to be the least integer greater than or equal to C Eq. 20.1
Kₘᵢₙ=└C┘, defined to be the greatest integer less than or equal to C Eq. 20.2

### Section 4.5.4: Interpretation of Degree of Production Concurrency

Given any two values for unit duration D and production interval I, the degree of production concurrency C may yield a value which provides an intuitive measure of how much work is performed concurrently. Given any two values for unit duration D and production interval I, the degree of maximum production concurrency Kₘₐₓ may yield a value which is an upper bound on how much work is performed concurrently, and correspondingly Kₘᵢₙ may be a lower bound on how much work is performed concurrently.

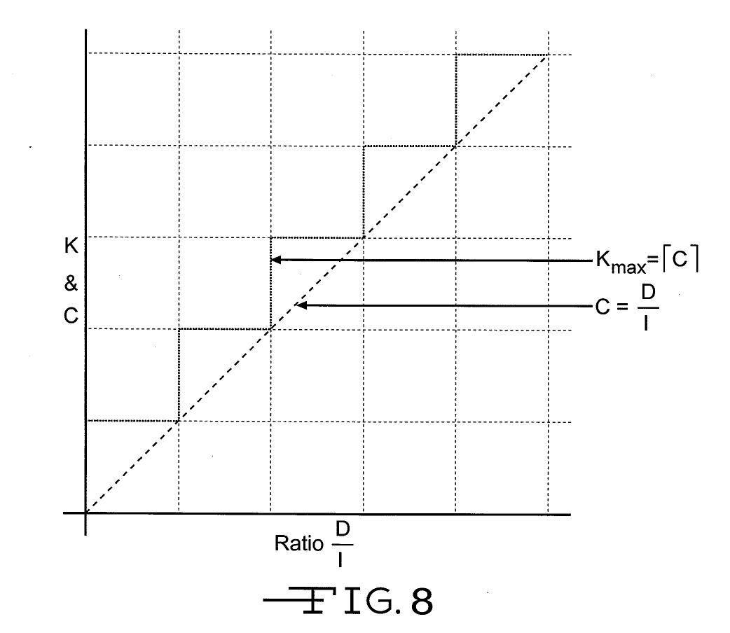

When, as illustrated in FIG. 3, D=3 and I=4, C=0.75, Kₘᵢₙ=0 and Kₘₐₓ=1, three quarters of the time one production unit may be in work, and one quarter of the time no work may be underway. When, as illustrated in FIG. 4, D=4 and I=4, C=1.00, Kₘᵢₙ=1 and Kₘₐₓ=1, at every point in time, exactly one production unit may be in work with perfect continuity from one unit of work to the next. When, as illustrated in FIG. 5, D=5 and I=4, C=1.25, Kₘᵢₙ=1 and Kₘₐₓ=2, three quarters of the time one production unit may be in work, and one quarter of the time two production units may be in work. When, as illustrated in FIG. 6, D=8 and I=4, C=2.00, Kₘᵢₙ=2 and Kₘₐₓ=2, at every point in time two production units may be in work, and when one unit of work completes, one unit may remain in work and another one may start. The relationship between the linear function C and step function Kₘₐₓ is illustrated in FIG. 8.

### Section 4.5.5: Relationship between Degree of Concurrency and Use of Dedicated or Shared Resources

When the degree of concurrency is less than or equal to 1 (C←1), no more than one production unit may be in work at any one time. In such cases, the resources applied to each production unit may be effectively dedicated to exactly one production unit at a time. When the degree of production concurrency is greater than 1 (C>1), then for at least some short period of time, more than one production unit may be in work. In such cases the resources applied to each production unit may be dedicated, shared, or a combination of both.

The degree of maximum concurrency Kₘₐₓ may be used to determine the quantity of dedicated Category 1 resources required in a given production context. Specific details are provided below.

### Section 4.6: Concepts and Measures of Duration

### Section 4.6.1: Unit Duration (D)

Unit duration D may be the duration of time required to complete one production unit, accomplished by the performance of a set of activities, making use of a set of resources. Unit duration D may be measured by the difference between the start time and the finish time of the set of activities required to complete one production unit. Duration may be measured in any conventional units, such as seconds, days, or years. However, use of a common fine granularity measure (such as seconds or minutes) may yield more accurate and more usable results than use of large granularity measures and fractional units (such as years and decimal parts). Unit duration may be further qualified with keywords and phrases such actual duration, target unit duration, predicted unit duration, estimated unit duration, minimum feasible unit duration, maximum unit duration, average unit duration, etc. that are defined separately, as necessary.

### Section 4.6.2: Fixed Unit Duration

When the duration of time required to complete one production unit may be unaffected and cannot be controlled by sequencing the constituent activities, by supply resources, and by other factors, the unit duration may be said to be fixed.

### Section 4.6.3: Flexible Unit Duration

When the duration of time required to complete one production unit may be affected and can be controlled by sequencing the constituent activities, by supply of resources, and by other factors, the unit duration may be said to be flexible.

### Section 4.6.4: Minimum Unit Duration (Dₘᵢₙ)

The minimum unit duration (Dₘᵢₙ) may be the minimum duration of time required to complete one production unit, when all constraints have been applied and when all means to reduce that duration have been exercised including sequencing of the constituent activities and supply of additional resources. In general, the minimum unit duration may be conveniently computed by constructing a schedule where all required constraints are enforced and all flexible resources are modeled as “infinite”.

### Section 4.6.5: Maximum Unit Duration (Dₘₐₓ)

The maximum unit duration Dₘₐₓ may be the maximum duration of time required to complete one production unit without introducing artificial gaps in the performance of work where no activity is underway. In general, the maximum unit duration may be conveniently computed by constructing a schedule where all required constraints are enforced and the activities are further constrained to be performed serially, without overlap. In cases where there are no extraordinary timing constraints, the maximum unit duration may be exactly the sum of the durations of the constituent activities.

### Section 5: Relationship Between Quantity of Resources and Production Interval and Unit Duration

Depending upon the nature of the work and the way that it is organized, the supply of resources may affect both unit duration and production interval. This application includes the following inter-related set of concepts, definitions, and formulae that together establish the mathematical foundation required to implement the methods of production rate and resource capacity planning:

Resource Dependent Production (Section 5.1);

Key Categories of Resource Requirements (Section 5.2);

Resource Dependent Production Interval (Section 5.3);

Resource Dependent Unit Duration (Section 5.4);

Shared Resources and Production Interdependence (Section 5.5); and

Concepts and Measures of Resource Utilization (Section 5.6).

### Section 5.1: Resource Dependent Production

### Section 5.1.1: Resource Dependent Production Interval

All work may be accelerated by decreasing the interval of time between start of successive production units (or equivalently by increasing the production rate). However, as the production interval decreases to a value less than or equal to the unit duration, concurrency may be introduced into production operations requiring an increase in dedicated and shared resources. When the production interval (or equivalently the production rate) of some body of repetitive work is affected and can be controlled by the quantity of resources supplied, it may be said to have a resource dependent production interval.

Generally, all work may have a resource dependent production interval. There are some circumstances where key resources (such as number of aircraft, number of assembly tools, or number of classrooms) may be fixed and it may be infeasible to exercise flexibility by increasing or decreasing those assets.

### Section 5.1.2: Resource Dependent Unit Duration

Some work, by its very nature, requires specific fixed resources for its performance and there may be no benefit if more resources are available. An example is the crew for an airline flight. An international flight may require a primary crew of one pilot and one co-pilot plus a relief crew of one additional pilot and one additional co-pilot. If all four individuals are available, the flight may proceed. If even one individual is missing, the flight may be held up, but the duration of the flight may be unaffected by and cannot be reduced by supplying additional crew.

Other work, by its very nature, requires some minimum resources for its performance but its duration depends upon the quantity provided. An example is large scale aircraft assembly. Given a few individuals of specific skill codes (electricians, mechanics, etc.), work proceeds very slowly resulting in long unit duration. Given larger number of individuals within those skill codes, work proceeds more rapidly resulting in short unit duration.

When the unit duration of some body of repetitive work may be affected and can be controlled by the quantity of resources supplied, it may be said to have resource dependent unit duration.

### Section 5.1.3: Independence of Unit Duration and Production Interval

When the production interval (or equivalently the production rate) of some body of repetitive work may be affected and may be controlled by the quantity of one category of resources available to dedicate to each production unit (such as assembly tooling), and when the unit duration may be affected and may be controlled by the quantity of a separate category of resources available to dedicate to each production unit (such as labor), production interval and unit duration may be effectively independent. In such cases, the quantity of resources in each category may be exercised separately to separately control production interval and unit duration.

### Section 5.1.4: Interdependence of Unit Duration and Production Interval

When the production interval (or equivalently the production rate) of some body of repetitive work may be affected and may be controlled by the quantity of one category of resources available to dedicate to each production unit (such as assembly tooling), and when the unit duration may be affected and may be controlled by the quantity of a separate category of resources shared across multiple concurrent production units (such as labor), production interval and unit duration may be effectively interdependent. Changes in quantity of the shared resources may affect both unit duration and the minimum feasible production interval (or equivalently the maximum feasible production rate).

### Section 5.2: Key Categories of Resource Requirements, Allocation, and Usage

Production operations of any scale may present complex combinations of resource requirements, allocation, and usage. For example, in large scale assembly a single production unit may require exclusive, dedicated use of special tooling (e.g. jig or fixture) for the duration of time required to complete the production unit, yet the quantity available may have no direct effect on the duration. Instead, the quantity available may simply determine how many production units may proceed concurrently, which may fall in Category 1.

In this same context, a single production unit may require use of labor in order to perform the work, and the quantity available may have direct effect on the time required to complete the production unit by enabling concurrency within the work required to complete one production unit. Here there may be two sub-cases. In one case, labor may be divided into segregated pools, where each pool is assigned exclusively to a single production unit for the duration, which may fall in Category 2. In the other case, labor may be managed within a single pool and shared across all production units, which may fall in Category 3.

Division of resource requirements, allocation, and usage into such categories may be necessary for systematic rate and capacity planning. However, within a single operational setting, the quantities provided must satisfy certain mathematical relationships described below, and the inter-relationships between them. For example, the quantity of Category 1 resources required may determined by the equations provided in Section 5.3, while the duration in that equation may be determined by the quantity of Category 2 resources provided and the equations in section 5.4. In other circumstances, the equations provided in Section 5.3 may determine the necessary or target duration and the equations of Section 5.4 may be used to determine the necessary quantity of Category 2 resources. In the same operational setting, there may be resources of Category 3, subject to the relationships defined in Section 5.5, while the overall degree of concurrency may be determined by the equations in Section 5.3.

### Section 5.2.1: Resources of Category 1

Resources of CategoryC 1 may comprise the following resources: (1) not-shared (and potentially not sharable) between production units; (2) with direct effect on concurrency between production units; and (3) with no effect on unit duration and degree of concurrency within the production unit.

### Section 5.2.2: Resources of Category 2

Resources of CategoryC 2 may comprise the following resources: (1) not-shared (although potentially sharable) between production units; (2) with no direct effect on concurrency between production units; (3) with direct effect on unit duration, by enabling concurrency within work required to complete one production unit.

### Section 5.2.3: Resources of Category 3

Resources of CategoryC 3 may comprise the following resources: (1) shared between production units; (2) with direct effect on the concurrency between production units, by enabling concurrent work on multiple production units; (3) with direct effect on unit duration, by enabling concurrency within work required to complete individual production units. Methods related to rate and capacity planning for shared resources, which fall under Category 3, will be addressed in a separate application.

### Section 5.3: Relationship between Category 1 Resource Availability and Production Interval

The following discussion may only apply to work where the degree of concurrency of some body of repetitive work may be affected and may be controlled by the quantity of resources supplied (resource dependent production interval), and where the quantity available may be increased or decreased to satisfy production demands (flexible resources). This discussion may be applicable to work where the key resources are dedicated to individual production units (not shared) and have no direct effect on unit duration. This may be relevant to manufacturing that is dependent upon the availability of dedicated tooling or machine tools, training that is dependent upon dedicated classrooms, flight operations that is dependent upon pilots or aircraft, etc.

Recall that Eq. 19.1 defines the degree of concurrency C as the ratio between unit duration D and production interval I. Also recall that Eq. 20.1 defines the degree of maximum production concurrency Kₘₐₓ as simply the least integer greater than or equal to C. In practice the quantity of dedicated Category 1 resources supplied for the performance of some repetitive work must be greater than or equal to Kₘₐₓ. If fewer resources are available, less work will be able to be performed concurrently, and target production rates (or equivalently interval) may not be met. Hence the relationship between the quantity of resources available Q₁ and the three parameters degree of concurrency, unit duration, and production interval is defined by the following:

$$\begin{matrix}{Q}_{1} \geq {K}_{max} , where {K}_{max} = ⌈ C ⌉ and C = \frac{D}{I} & Eq . 21.1 \\ {Q}_{1} \geq ⌈ \frac{D}{I} ⌉ & Eq . 21.2\end{matrix}$$

### Section 5.4: Relationship between Category 2 Resource Availability and Unit Duration

The following discussion may only apply to work where the unit duration of some body of repetitive work may be affected and may be controlled by the quantity of dedicated resources supplied (resource dependent duration) and where the quantity available may be increased or decreased to satisfy production demands (flexible resources). This may be most applicable to work which may be decomposed into a large number of individual activities which may be flexibly rearranged to take advantage of the availability of the dedicated Category 2 resources. This may be relevant to large scale assembly that is dependent upon the availability of a labor pool of flexible size, maintenance that is dependent upon a labor pool of flexible size, or cleaning service that is dependent upon a labor pool of flexible size, etc.

### Section 5.4.1: Work Content and Resource Dependent Unit Duration

Consider a case where the work required to complete one production unit has been quantified as 210 labor-hours. It is imaginable that this work might be complete by 1 person working 210 hours in duration, 2 people working 105 hours, 3 people working 70 hours, 5 people working 42 hours, 7 people working 30 hours, or other combinations where the product of the number of people and the unit duration, measured in hours, yields 210. Yet it is equally clear, because of physical constraints on the performance of work, that duration and resources may never be perfectly exchanged one for the other.

### Section 5.4.2: Constraints on the Performance of Work

When the work to be performed is accomplished by performing a collection of individual activities there are likely to be constraints on the performance of the individual activities. Without elaborating on all of the possibilities, assume at a minimum that the constituent tasks have documented resource requirements and may be subject to inter-task precedence constraints.

### Section 5.4.2.1: Precedence Constraints

If one activity A is constrained to occur before another activity B, then it may be prohibited for B to occur before A or to be performed concurrent with A even for some short period of time. The net effect may be that the effective duration of performing activities A and B is at least the duration of A plus the duration of B. If the work required to complete one production unit is accomplished by performing a collection of individual activities which are subject to some specified precedence constraints, then there may be some minimum duration for that work that results from enforcing those constraints. If a collection of activities is subject to precedence constraints, then the minimum duration for that work may not be less than the duration of the critical path (computed using conventional algorithms).

### Section 5.4.2.2: Minimum Resource Requirements

If the work required to complete one production unit is accomplished by performing a collection of individual activities it is likely that some activities themselves may have a minimum resource requirement and cannot be performed unless that minimum quantity of resources is available.

### Section 5.4.3: Estimating the Relationship between Resource Availability and Unit Duration

Eq. 13.3 defines the work content w for one activity as the product of unit duration d and quantity of resources q. Eq. 14.1 further refines that definition for those cases where the work to be performed is accomplished by a collection of individual activities, each of which has a specified duration and quantity of resources required.

Using these equations as a guide, the functional relationship between Resource Availability and Unit Duration may be clear and simple. For a body of work with fixed work content W, the unit duration D may be decreased by increasing the quantity of resources provided Q.

While Eq. 13 may be commonly used in industry to perform rate and capacity planning, the actual relationship between resource availability and unit duration may be more complex. Use of these equations may lead to erroneous results, which then must be adjusted based upon actual operational performance. These equations may be inadequate because unit duration may be affected by the constraints between the constituent activities, the minimum feasible duration, per activity minimum resource requirements, the degree of concurrency between activities, and other factors.

A more general, parametric equation is required which can be instantiated with parametric values derived from analytic studies and empirical data which take these effects into consideration. Using Eqs. 1, 2, and 13 as a basis, the simplest parametric formulae that relate Category 2 resource availability (Q₂) to unit duration (D), given fixed work content, comprises the following pair of equations:

$$\begin{matrix}D = a + \frac{b}{( {Q}_{2} - c )} & Eq . 22.1 \\ {Q}_{2} = \frac{( D - a ) \cdot c + b}{( D - a )} & Eq . 22.2\end{matrix}$$

Work that is composed of many small, loosely constrained activities may fit this equation well, while work that is compose of only a few, tightly constrained activities may fit this equation poorly.

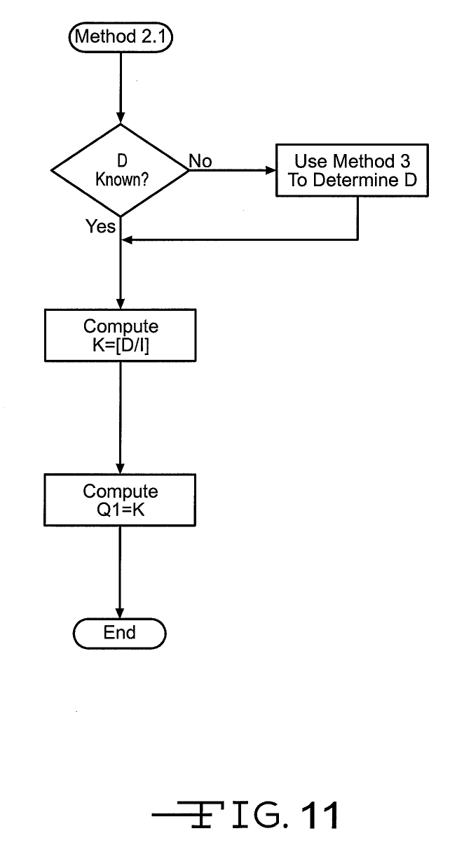

Methods for estimating values for the parameters a, b, and c were provided in Section 2. Methods for performing the necessary empirical trials will be discussed below. Reflection on Eq 22.1 and FIG. 11 establishes one of the most significant implications of the Parametric Model of Unit Duration: production is governed by the Law of Diminishing Returns. After a certain point, attempts to reduce unit duration through application of increasing quantity of Category 2 resources may become unaffordable.

### Section 5.5: Concepts and Measures of Resource Utilization

Resource utilization may be measured as the percentage of provided resources that are used in the performance of work. It is generally computed as a ratio where the numerator is the quantity of resources used and the denominator is the quantity of resources provided and then presented as a decimal, fraction, or percentage.

### Section 5.5.2: Utilization of Category 1 Resources

As discussed above, it may be difficult to relate use of Category 1 resources to work content or work accomplished. Nevertheless the utilization of Category 1 resources may be easily determined by consideration of concurrency between production units.

For repetitive production of a body of work with production interval I and unit duration D, the degree of concurrency C may be an average measure of how many production units are concurrently in work. At the same time Kₘₐₓ may be the minimum number of Category 1 resources required to sustain the target rate and production interval. Assuming that the quantity of Category 1 resources provided Q₁ is equal to Kₘₐₓ, the maximum utilization of Category 1 resources U₁ may be determined by the following:

$${U}_{1} = \frac{C}{{Q}_{1}} , where \\ C = \frac{D}{I} , {K}_{max} = ⌈ C ⌉ , and {Q}_{1} = {K}_{max} \qquad Eq . 23$$

### Section 5.5.2: Utilization of Category 2 Resources

The resource content (where appropriate, also referred to as labor content) over some duration of time d as performed by a dedicated pool of resources may be simply the product of the quantity of resources provided Q and the duration of time d, as defined in the following:
L=Q·d Eq. 24

Based upon this definition, resource utilization over some period of time may be defined as the ratio of total work content accomplished T to resource content provided L, as defined in the following:

$$U = \frac{T}{L} \qquad Eq . 25$$

Hence for a given allocation of Category 2 resources the following may apply:

$${U}_{2} = \frac{T}{{Q}_{2} \cdot D} \qquad Eq . 26$$

But since unit duration D may be determined by a function of the quantity of resources provided, utilization of a given quantity of resources may be in fact determine solely by the nature of the work and the quantity of resources provided. Making use of Eq. 22 for a single production unit with a dedicated quantity of Category 2 resources Q₂, the net labor content L over the duration of one production unit can be determined using the following equation (as parameterized by a, b, and c):

$$L = {Q}_{2} \cdot D = {Q}_{2} \cdot ( a + \frac{b}{( {Q}_{2} - c )} ) \qquad Eq . 27$$

Hence the corresponding resource utilization for a given quantity of Category 2 resources (Q₂) may be estimated by:

$${U}_{2} = \frac{T}{{Q}_{2} \cdot ( a + \frac{b}{( {Q}_{2} - c )} )} \qquad Eq . 28$$

### Section 6: Overview of the Defined Methods

### Section 6.1: Key Questions

The example questions first introduced in Section 2 can now be more precisely stated and expanded to include additional, naturally related, questions as follows:
(Q1) Given a number of fixed Category 1 resources, where each will be dedicated to one production unit at a time, and a fixed unit duration, what is the minimum sustainable production interval (or equivalently maximum sustainable production rate):
(Q2) Given a number of fixed Category 1 resources, where each will be dedicated to one production unit at a time, and a fixed production interval (or equivalently production rate), what is the maximum acceptable unit duration:
(Q3) Given a fixed unit duration and a fixed production interval (or equivalently production rate), what quantity of fixed Category 1 resources are required, where each will be dedicated to one production unit at a time?
(Q4) Given a fixed quantity of Category 2 resources for non-concurrent performance of one production unit, what is the minimum achievable unit duration for performance of that work?
(Q5) Given a target unit duration, what is the minimum quantity of dedicated Category 2 resources required to achieve that target unit duration in non-concurrent performance of one production unit?
(Q6) Given a number of fixed Category 1 resources, where each will be dedicated to one production unit at a time, a fixed unit duration, and a fixed production interval (or equivalently fixed production rate), what is the effective utilization of those resources?
(Q7) Given a fixed quantity of Category 2 resources for non-concurrent performance of one production unit, and a fixed unit duration for performance of that work, what is the effective utilization of those resources?

### Section 6.2: Relationship of Defined Methods to Key Questions

In the following sections, MethodM 1 may be used to select the appropriate supporting method based upon information that is known, and the operational question to be answered. Method 2 may address questions Q1, Q2, and Q3. Method 3 may address questions Q4 and Q5. Method 4 may address Questions Q6 and Q7. Method 5 may define a process for creating a parametric model of unit duration. Method 6 may define a process for creating a family of quantized resource vectors. Method 7 may define a process for creating a work content vector and for determining total work content.

### Section 6.3: Use of the Defined Methods

Successful use of the defined methods may require use of computerized scheduling software and construction of the necessary resource models, activity models, and production models. It may also require construction of schedules using the computerized software, analysis and interpretation of the results, etc.

A skilled practitioner in the art of production rate and resource capacity planning will readily recognize that one or more embodiments of the methods disclosed herein may provide simple systematic means to solve problems which previously may only have been solved with ad hoc, trial and error methods.

### Section 6.4: Implementation of the Defined Methods

The below methods are presented as numbered steps to be performed in order, except as otherwise specified (e.g. use method x, or go to step y). In this form, they may be reasonably implemented as computer programs or rendered as flowcharts, paper workbooks or computerized spreadsheets. In other embodiments, derivative implementations of these methods may be utilized.

### Section 6.5: Preferred Implementation

The below methods require construction of schedules, based upon input resource models, activity models, and production models. For the most part, any computerized scheduling system may be sufficient, but the preferred implementation may utilize an optimizing scheduler so that the resulting production plans generally minimize unit duration, maximize production rate, and minimize required resources. An optimizing scheduler, as described in U.S. Pat. No. 5,890,134 which is hereby incorporated by reference, may satisfy both of these requirements.

### Section 6.6: Alternative Methods

It should be recognized that derivative forms of the below methods, in addition to other types of methods, may be used which incorporate alternative combinations of the below methods. Methods related to rate and capacity planning for shared resources of type Category 3 will be covered in a separate patent application.

### Section 7: Defined Methods

### Section 7.1: Method 1

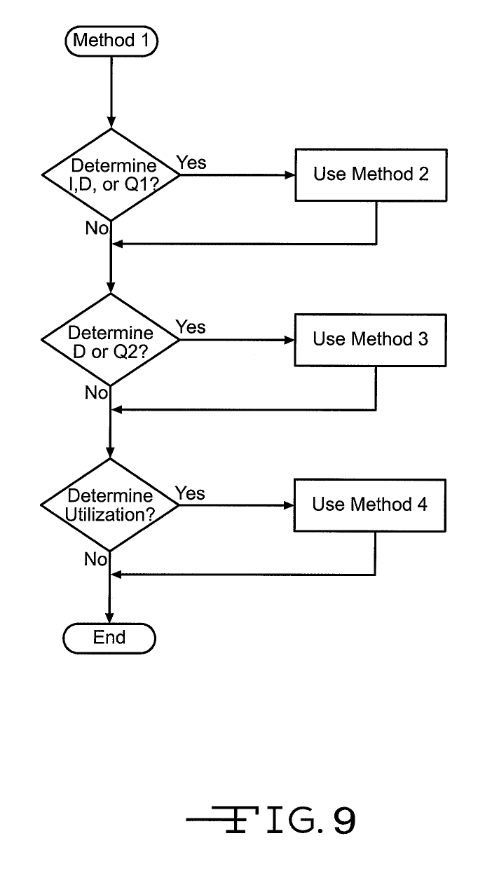

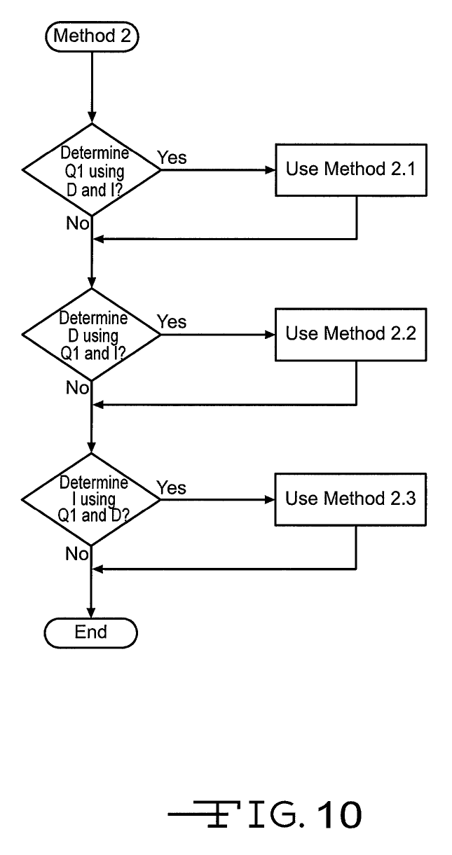

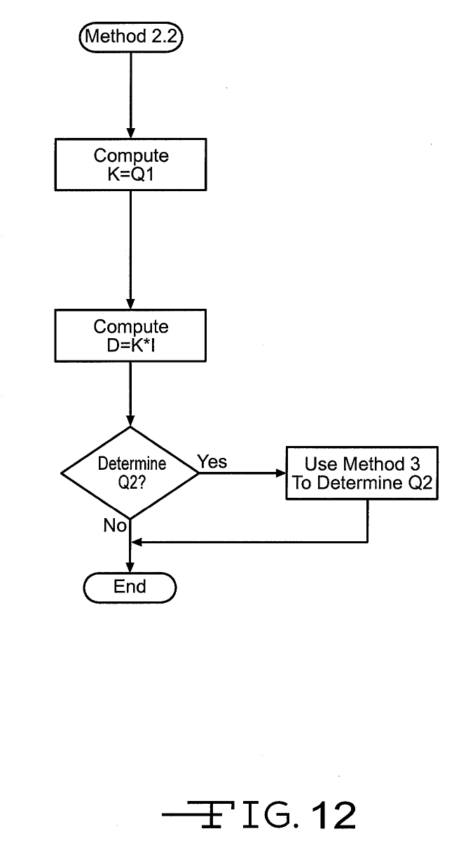

A flow chart of Method 1 is shown in FIG. 9. As shown in FIG. 9, the selection of the appropriate method for production rate and capacity planning based upon the objective and available information utilizes the following steps:
(1) If the objective is to determine quantity of dedicated Category 1 resources Q₁, unit duration D, or production interval I, given two of these three values, use Method 2 (a flow chart of Method 2 is shown in FIG. 10).
(2) If the objective is to determine quantity of dedicated Category 2 resources Q₂ required to achieve a given unit duration D or the minimum unit duration D that can be achieved with a given quantity of dedicated Category 2 resources Q₂, use Method 3 (a flow chart of Method 3 is shown in FIG. 11).
(3) If the objective is to determine the utilization of Category 1 or Category 2 resources use Method 4 (a flow chart of Method 4 is shown in FIG. 12).
(4) End

### Section 7.2: Method 2

A flow chart of Method 2 is shown in FIG. 10. As shown in FIG. 10, the determination of the quantity of dedicated Category 1 resources Q₁, unit duration D, or production interval I, given fixed or target values for two of the three values Q1, D, or I, using the Parametric Model of Production Concurrency utilizes the following steps:
(1) If the objective is to determine the minimum acceptable quantity of dedicated Category 1 resources Q₁, given fixed or target values for unit duration D and production interval I, use Method 2.1 (a flow chart of Method 2.1 is shown in FIG. 11).
(2) If the objective is to determine the maximum acceptable unit duration D, given fixed or target values for quantity of dedicated Category 1 resources Q₁ and production interval I, use Method 2.2 (a flow chart of Method 2.2 is shown in FIG. 12).
(3) If the objective is to determine the minimum acceptable production interval I, given fixed or target values for quantity of dedicated Category 1 resources Q₁ and unit duration D, use Method 2.3 (a flow chart of Method 4 is shown in FIG. 13).
(4) End

### Section 7.2.1: Method 2.1

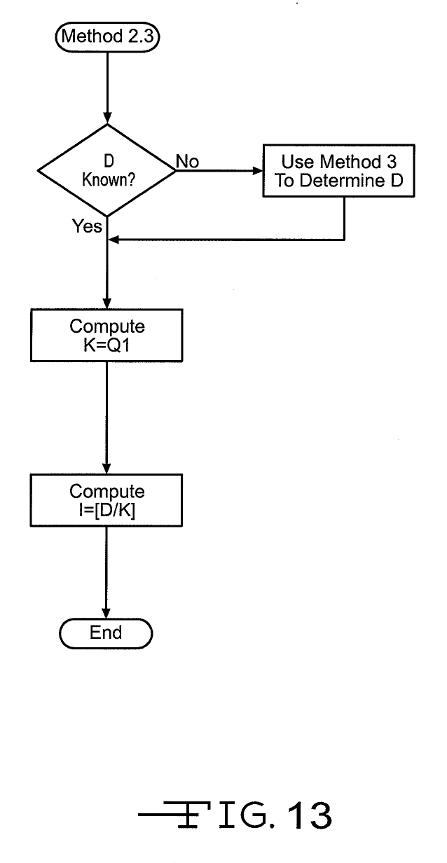

A flow chart of Method 2.1 is shown in FIG. 11. As shown in FIG. 11, given fixed or target values for unit duration D and production interval I, determining the minimum acceptable quantity of dedicated Category 1 resources Q1 utilizes the following steps:
(1) If the value for unit duration D is known, go to step 3.
(2) Use Method 3 to determine minimum feasible unit duration D, using the quantity of dedicated Category 2 resources Q₂ provided to complete one production unit (a flow chart of Method 3 is shown in FIG. 14)
(3) Compute the maximum degree of concurrency K that will occur during the course of production using

$$K = ⌈ \frac{D}{I} ⌉$$
(4) Compute the required quantity of dedicated, Category 1 resources Q₁, using
   Q₁=K
(5) End

### Section 7.2.2: Method 2.2

A flow chart of Method 2.2 is shown in FIG. 12. As shown in FIG. 12, given fixed or target values for the quantity of dedicated Category 1 resources Q1 and production interval I, determining the maximum acceptable unit duration D utilizes the following steps:
(1) Compute the maximum acceptable degree of concurrency K using
   K=Q₁
(2) Compute the maximum acceptable unit duration D using
   D=K·I
(3) If it is not desired to determine the minimum quantity of Category 2 resources Q₂ required to achieve unit duration D go to step 5.
(4) Use Method 3 to determine minimum quantity of dedicated Category 2 resources Q₂ required to complete one production unit in duration D (a flow chart of Method 3 is shown in FIG. 14)
(5) End

### Section 7.2.3: Method 2.3

A flow chart of Method 2.3 is shown in FIG. 13. As shown in FIG. 13, given fixed or target values for the quantity of dedicated Category 1 resources Q1 and unit duration D, determining the minimum acceptable production interval I utilizes the following steps:
(1) If the value for unit duration D is known, go to step 3.
(2) Use Method 3 to determine minimum feasible unit duration D, using the quantity of dedicated Category 2 resources Q₂ provided to complete one production unit (a flow chart of Method 3 is shown in FIG. 14)
(3) Compute the maximum degree of concurrency using
   K=Q₁
(4) Compute the minimum acceptable production interval I using

$$I = ⌈ \frac{D}{K} ⌉$$
(5) End

### Section 7.3: Method 3

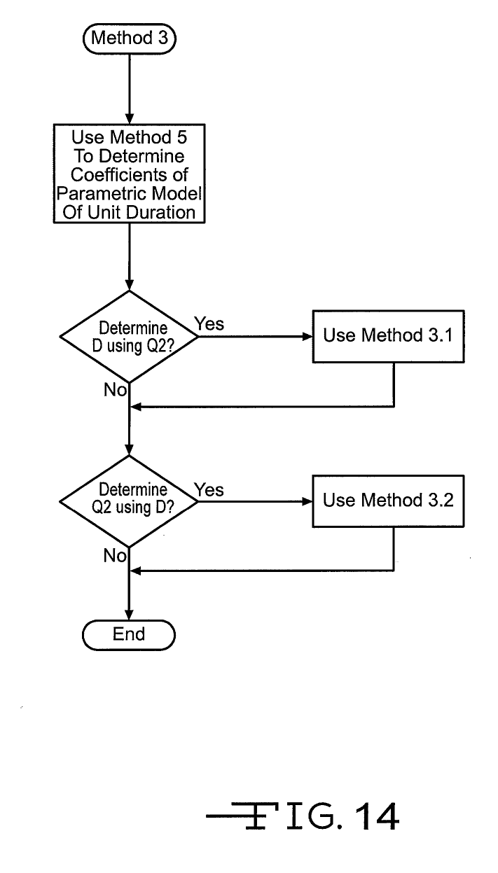

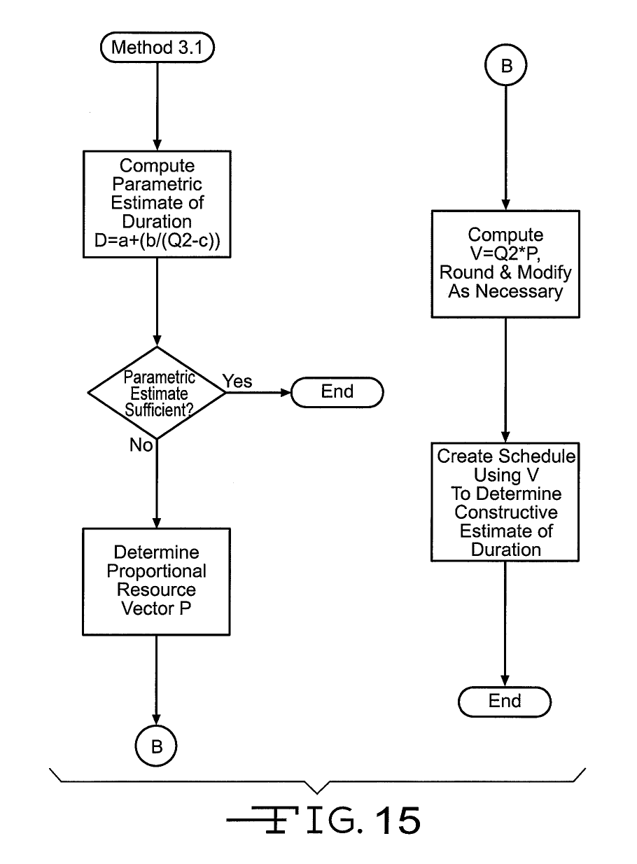

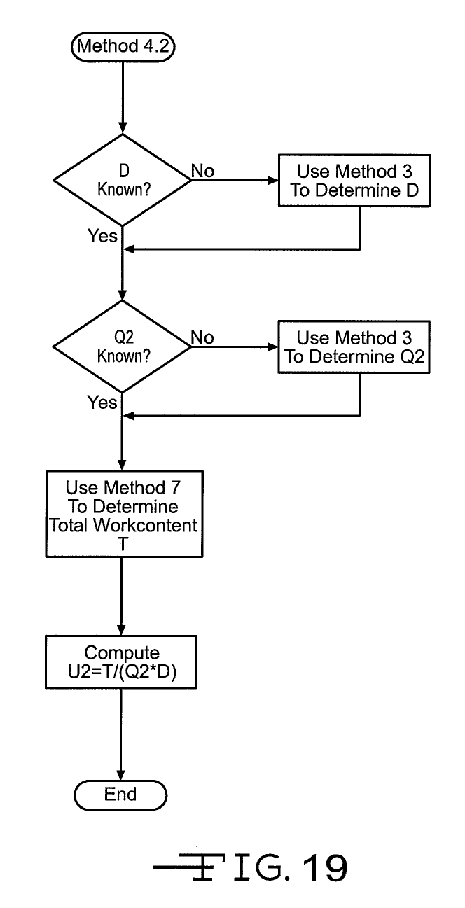

A flow chart of Method 3 is shown in FIG. 14. As shown in FIG. 14, determining the quantity of dedicated Category 2 resources Q₂ required to achieve a given unit duration D or minimum unit duration D that can be achieved with a given quantity of dedicated resources Q₂, using the Parametric Model of Unit Duration utilizes the following steps:
(1) Use Method 5 to compute the coefficients a, b, and c of the Parametric Model of Unit Duration (a flow chart of Method 5 is shown in FIG. 20)
(2) If the objective is to determine the minimum unit duration D that can be achieved with a given quantity of dedicated resources Q₂, use Method 3.1 (a flow chart of Method 3 is shown in FIG. 15)
(3) If the objective is to determine quantity of dedicated resources Q₂ required to achieve a given unit duration D, use Method 3.2 (a flow chart of Method 3 is shown in FIG. 16)
(4) End

### Section 7.3.1: Method 3.1

A flow chart of Method 3.1 is shown in FIG. 15. As shown in FIG. 15, given a quantity of dedicated resources Q₂, determining the minimum unit duration D that can be achieved utilizes the following steps:
(1) Compute a parametric estimate for the value for unit duration D using the Parametric Model of Unit Duration: (a flow chart of Method 5 is shown in FIG. 20)

$$D = a + \frac{b}{( {Q}_{2} - c )}$$
(2) If a parametric estimate is sufficient go to step 6
(3) Using the proportional resource vector P as constructed in Method 5, compute a working resource vector V using (a flow chart of Method 5 is shown in FIG. 20)
   V=Q₂·P;
(4) Round or modify elements of V as necessary to satisfy minimum resource requirements.
(5) Construct a schedule using V to determine a constructive estimate of unit duration D.
(6) End

### Section 7.3.2: Method 3.2

A flow chart of Method 3.2 is shown in FIG. 16. As shown in FIG. 16, given a target unit duration D, determining the quantity of dedicated resources Q₂ required utilizes the following steps:
(1) Compute a parametric estimate for quantity of dedicated Category 2 resources Q₂ using the inverse formulation of the Parametric Model of Unit Duration

$${Q}_{2} = \frac{( D - a ) \cdot c + b}{( D - a )}$$
(2) If a parametric estimate is sufficient go to step 12.
(3) Using the proportional resource vector P constructed in Method 5, and the current value of Q₂, compute a working resource vector V using (a flow chart of Method 5 is shown in FIG. 20)
   V=Q₂·P
(4) Round or modify elements of V as necessary to satisfy minimum resource requirement
(5) Construct a schedule using V to determine minimum feasible unit duration Dᵥ
(6) If the resulting unit duration Dᵥ is sufficiently close to target duration D go to step 12
(7) If the resulting unit duration is greater than the target duration D go to step 10
(8) Decrease Q₂
(9) Go to step 3
(10) Increase Q₂
(11) Go to step 3
(12) End
   Note: Since Q₂ is a scalar value, this process will quickly produce estimated values for Q₂ that will bound the target duration D.

### Section 7.4: Method 4

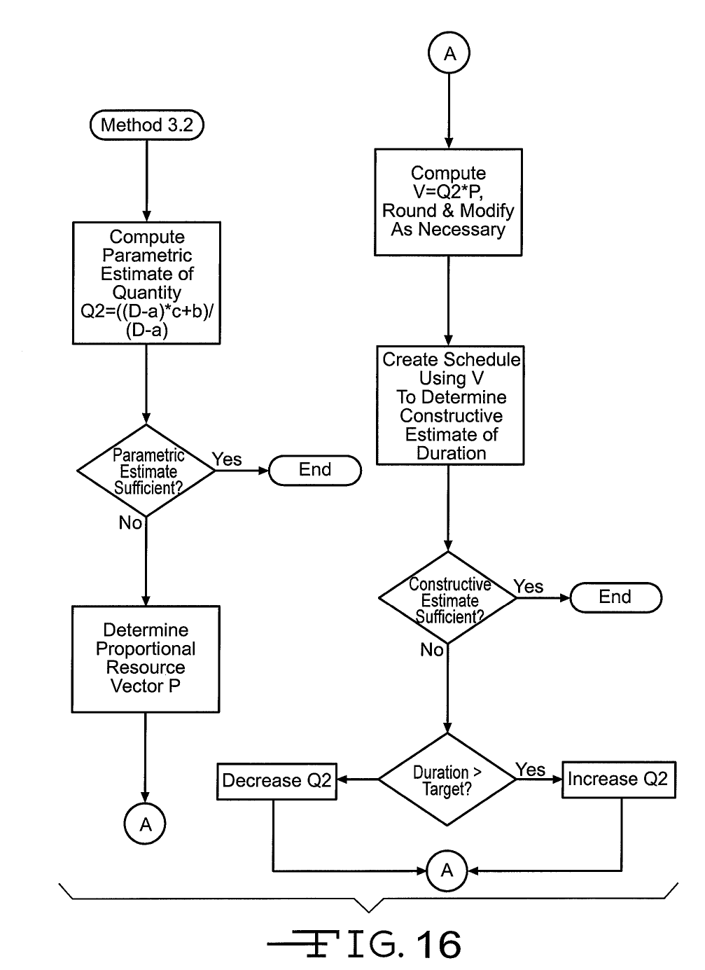

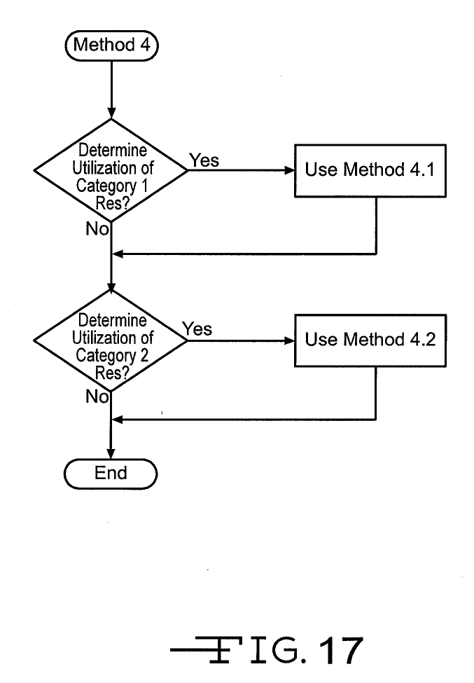

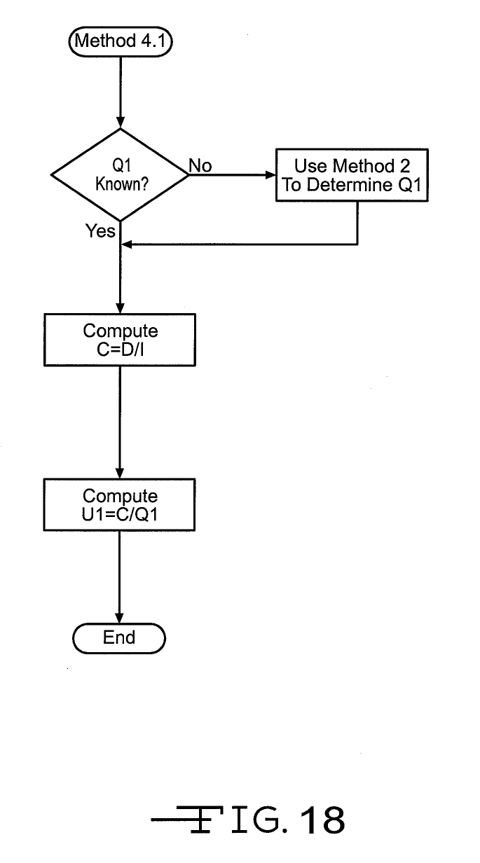

A flow chart of Method 4 is shown in FIG. 17. As shown in FIG. 17, selecting the appropriate method for estimating resource utilization based upon the objective and available information utilizes the following steps:
(1) If the objective is to determine utilization of dedicated Category 1 resources, given known quantities for unit duration D and production interval I or quantity of dedicated resources Q₁ use Method 4.1 (a flow chart of Method 4.1 is shown in FIG. 18)
(2) If the objective is to determine utilization of dedicated Category 2 resources, given know quantities for unit duration D or quantity of dedicated resources Q₂ use Method 4.2 (a flow chart of Method 4.2 is shown in FIG. 19)
(3) End

### Section 7.4.1: Method 4.1

A flow chart of Method 4.1 is shown in FIG. 18. As shown in FIG. 18, determining utilization of dedicated Category 1 resources utilizes the following steps:
(1) If the quantity of Category 1 resources Q₁ is known go to step 3.
(2) Use Method 2 to determine required quantity of Category 1 resources Q₁, given unit duration D and production interval I (a flow chart of Method 2 is shown in FIG. 10)
(3) Compute degree of concurrency C using

$$C = \frac{D}{I}$$
(4) Compute resource utilization U₁ using

$${U}_{1} = \frac{C}{{Q}_{1}}$$
(5) End

### Section 7.4.2: Method 4.2

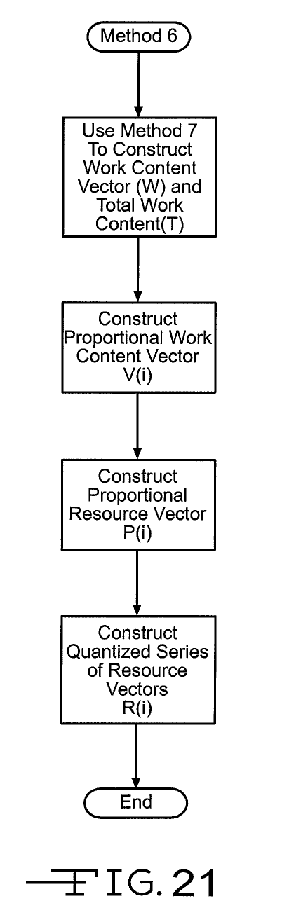

A flow chart of Method 4.2 is shown in FIG. 19. As shown in FIG. 19, determining utilization of dedicated Category 2 resources utilizes the following steps:
(1) If the unit duration D is known go to step 3
(2) Use Method 3 to determine unit duration D given provided quantity of Category 2 resources Q₂ (a flow chart of Method 3 is shown in FIG. 14)
(3) If the quantity of Category 2 resources Q₂ is known go to step 5
(4) Use Method 3 to determine quantity of Category 2 resources Q₂ required given target unit duration D (a flow chart of Method 3 is shown in FIG. 14)
(5) Use Method 7 to determine total work content T (a flow chart of Method 7 is shown in FIG. 22)
(6) Compute resource utilization U2 using

$${U}_{2} = \frac{T}{{Q}_{2} \cdot D}$$
(7) End

### Section 7.5: Method 5

A flow chart of Method 5 is shown in FIG. 20. As shown in FIG. 20, determining coefficients a, b, and c of the Parametric Model of Unit Duration utilizes the below steps:

$$D = a + \frac{b}{( q - c )}$$

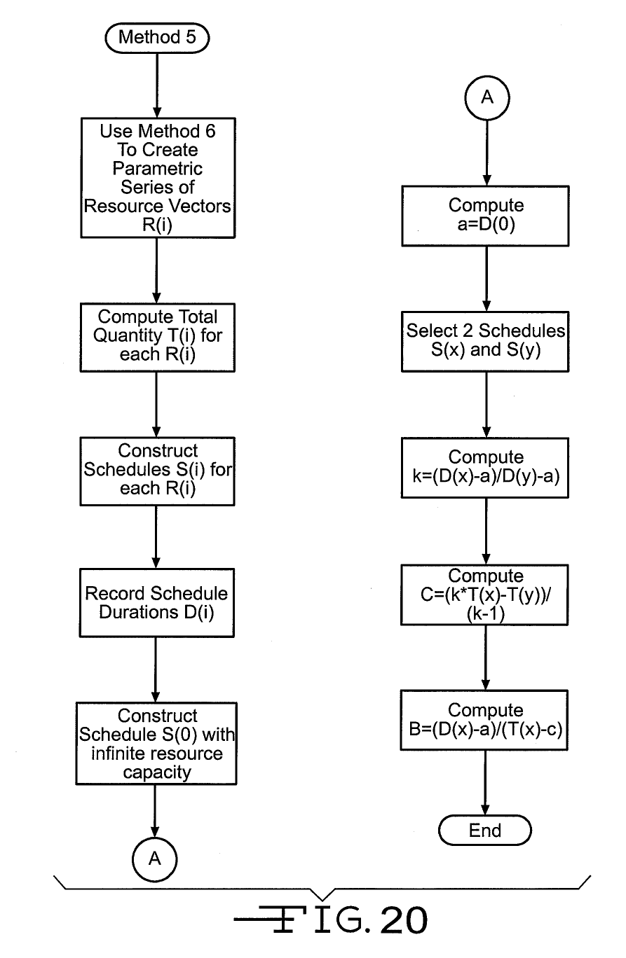

(1) Use Method 6 to create a Parametric Series of n Resource Vectors (a flow chart of Method 6 is shown in FIG. 21)
   (Rᵢ, i=1,n)
(2) For each member of the parametric series of n resource vectors, record the total resource quantity
   (Tᵢ, i=1,n)
(3) For each member of the parametric series of n resource vectors, construct a single-unit schedule
   (Sᵢ, i=1,n)
(4) For each member of the parametric series of n single-unit schedules, record the unit duration
   (Dᵢ, i=1,n)
(5) Construct one additional schedule S₀ where the resource capacity provided is infinite and record the resulting unit duration D₀.
(6) Using the schedule constructed using infinite resource capacity S₀ and the corresponding the unit duration D₀, compute a using
   a=D₀
(7) Using two selected schedules Sₓ and S_{y}, and the corresponding unit durations Dₓ and D_{z}, compute k using

$$k = \frac{( {D}_{x} - a )}{( {D}_{y} - a )}$$
(8) Using the same two selected schedules Sₓ and S_{y}, and the corresponding total resource quantities Tₓ and T_{y}, compute c using

$$c = \frac{( k \cdot {T}_{x} - {T}_{y} )}{( k - 1 )}$$
(9) Using one of the selected schedules Sₓ, and the corresponding unit duration Dₓ and resource quantity Tₓ, compute b using
   b=(Dₓ−a)·(Tₓ−c)
(10) End

### Section 7.6: Method 6

A flow chart of Method 6 is shown in FIG. 21. As shown in FIG. 21, creating a Parametric Series of Resource Vectors utilizes the following steps:
(1) Use Method 7 to construct a work content vector Wand to determine total work content T (a flow chart of Method 7 is shown in FIG. 22)
(2) Construct a proportional work content vector V=v₁, v₂, v₃, . . . vₘ where for each of the m elements of V, compute the value of vⱼ using

$${v}_{j} = \frac{{w}_{j}}{T}$$
(3) Construct a proportional resource vector P=p₁, p₂, p₃, . . . pₘ where for each of the m elements of P, compute the value of pⱼ using
   pⱼ=vⱼ
(4) Construct a quantized series of n resource vectors Rᵢ, i=1,n, where for each of the n elements of the series, compute the value of Rᵢ using
   Rᵢ=i·d·P
   wherein d is selected to produce a suitable range of resource vectors.
(5) End

### Section 7.7: Method 7

A flow chart of Method 7 is shown in FIG. 22. As shown in FIG. 22, constructing a work content vector and determining total work content utilizes the following steps:
(1) For each of k tasks Tᵢ, i=1,k required to complete one production unit, document the resources required to perform the respective tasks.
(2) Divide the resource requirements documented in step 1 into m resource categories Cⱼ, j=1,m as is most relevant to this work. (e.g. labor requirements may be divided separate skill codes).
(3) For each of k tasks Tᵢ, i=1,k required to complete one production unit, tabulate the quantity of resources required in each of the m resource categories, representing the resource requirements for task Tᵢ as a vector Rᵢ=r₁, r₂, r₃, . . . rₘ where rⱼ=the quantity of resources required in category Cⱼ
(4) For each of k tasks Tᵢ, i=1,k required to complete one production unit, tabulate the task duration d_{i, i=1 . . . n}.
(5) Construct a work content vector W=w₁, w₂, w₃, . . . wₘ where for each of the m elements of W, compute the value of wⱼ using

$${w}_{j} = {\sum }_{i = 1}^{n} {d}_{i} \cdot {r}_{j}^{i}$$

where dᵢ=the duration of task i and

where rⱼⁱ=the quantity of resource category j required by task i
(6) Compute the total work content T for one production unit using

$$T = {\sum }_{j = 1}^{m} {w}_{j}$$
(7) End

### EXAMPLE

Rate and Capacity planning comes in many forms, depending upon the circumstance and what information is known and what information is desired. The defined methods have been designed to support virtually every analysis that is mathematically feasible using Method 1 as a starting point. A planner, skilled in the art of rate and capacity planning, may use the defined methods flexibly, and possibly in different order, according to circumstance.

Two examples are provided below along with the background data necessary to illustrate use of the defined methods. In these examples, suppose that a business has introduced a new product that requires manufacture and that the rate of production must be balanced against market demands and manufacturing capacity. Each example will state what information is known and fixed, will identify what information is desired in the form of one or more questions, and will trace the steps required to answer those questions using the defined methods.

### Background Data

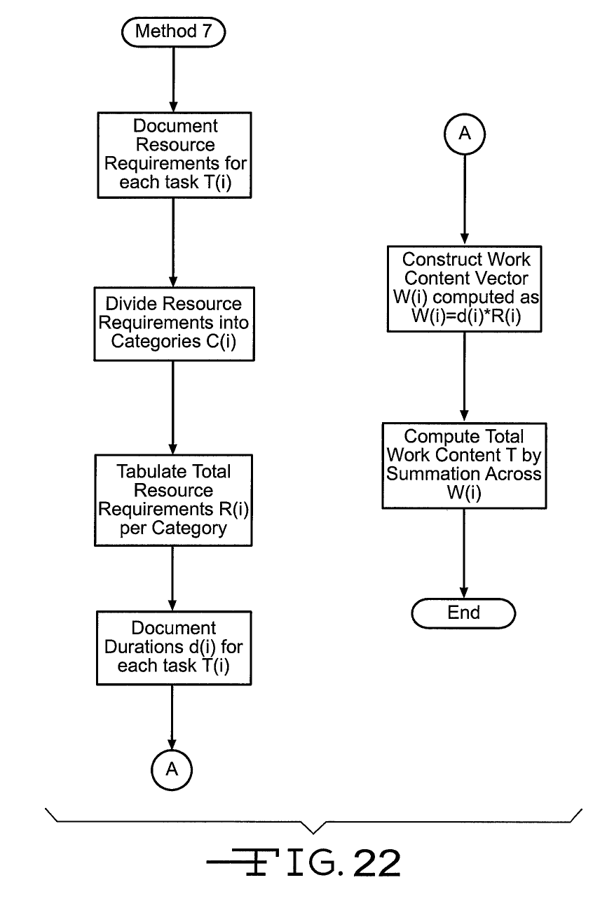

To establish the background for this example and to facilitate quick illustration of the defined methods, consider the data provided in the Table of FIG. 23. The content of this table has been constructed as prescribed in Methods 5, 6, and 7.
Column A contains the resource categories required for the performance of the planned work.
Column B contains the work content vector (the summation over all tasks of the work content required per resource category). The number at the bottom of the column shows the total work content (summation over all tasks and all resource categories).
Column C contains the proportional resource vector, presented as percent of total resource requirement.
Column D contains a tabulation of minimum quantity required in each resource category, based upon the resource requirements of individual tasks.
Columns E contain the Parametric Resource Vectors, constructed from the proportional resource vector, the minimum resource requirements, and vector multiplication by the quantities i and d. The numbers at the bottom of these columns show the total quantity of resources provided.

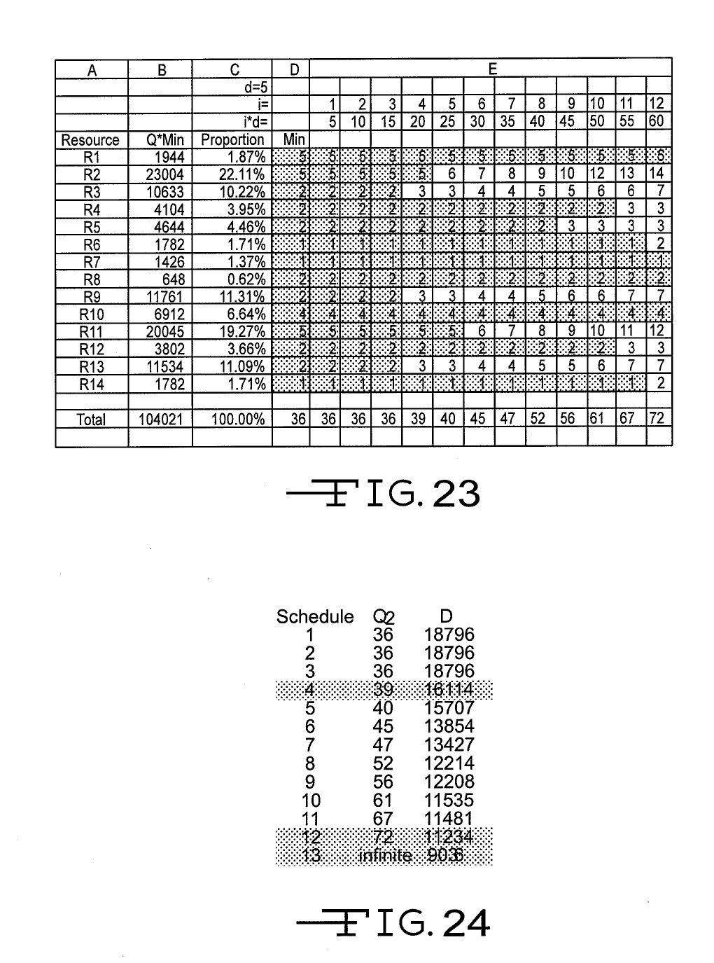

Using this data, 12 schedules have been constructed using the corresponding parametric resource vectors along with one additional schedule constructed using infinite capacity. The resource quantity and resulting unit duration are tabulated as shown in the Table of FIG. 24. Schedules 4, 12, and infinite have been shaded to indicate that they will be selected for use in application of Method 5.

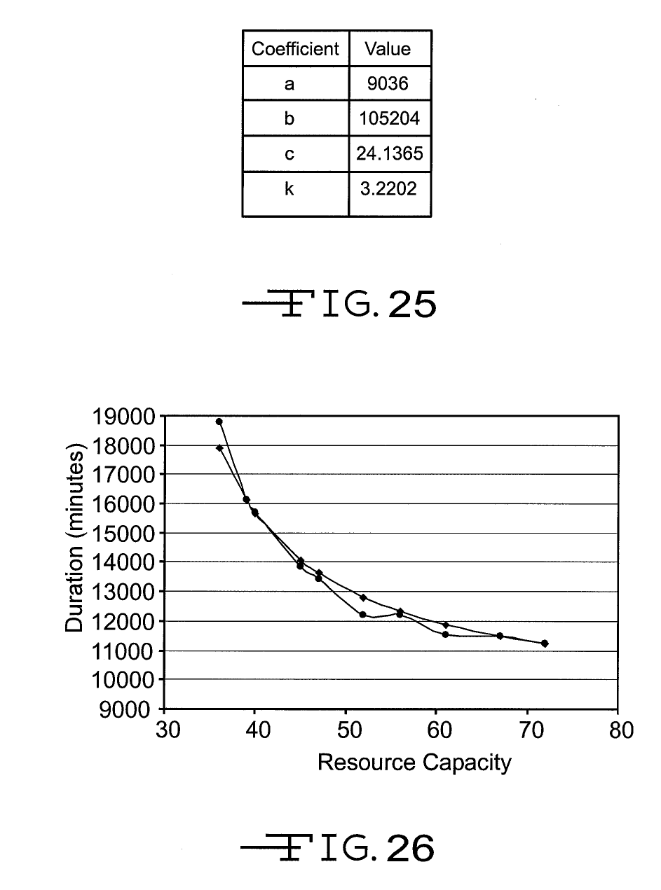

The coefficients of the Parametric Model of Unit Duration, as determined by Method 5, are shown in the Table of FIG. 25. The application of Method 5 is detailed below.

The functional relationship between the quantity of Category 2 resources provided and the resulting unit duration as determined by the Parametric Model of Unit Duration, with an overlay of the empirical data from the Table of FIG. 24, is shown in the graph of FIG. 26.

### Example 1

### Suppose that Market Demand Requires Completion of One Production Unit Every 8 Working Days and that the Quantity of Category 1 Resources is 2

What unit duration must be achieved to support this rate?
What quantity of Category 2 resources is required to achieve this unit duration?

Beginning with Method 1, make use of Method 2 and then Method 2.2 to determine the necessary unit duration. According to Method 2.2 determine the unit duration as a result of performing the below recited steps. Given fixed or target values for the quantity of dedicated Category 1 resources Q1=2 and production interval I=8, determine the maximum acceptable unit duration D.
(1) Compute the maximum acceptable degree of concurrency K using
   K=Q₁=2
(2) Compute the maximum acceptable unit duration D using
   D=K·I=2·8=16 days=16·(15·60)=14400 minutes

(where working days consist of two 7.5 hours shifts)
(3) If it is not desired to determine the minimum quantity of Category 2 resources Q₂ required to achieve unit duration D go to step 5
(4) Use Method 3 to determine minimum quantity of dedicated Category 2 resources Q₂ required to complete one production unit in duration D.
(5) End

Continuing with Step 44 of Method 2.2 make use of Method 3 to determine the quantity of Category 2 resources required per unit. According to Step 1 of Method 3, determine coefficients of the Parametric Model of Unit Duration using Method 5. In the context of Method 5, assume that the Parametric Series of Resource Vectors has been constructed as shown in the Table of FIG. 23 and that a series of schedules have been constructed, recording the resulting durations as shown in the Table of FIG. 24, and that schedules 4 and 12 are selected for necessary computations, satisfying the intent of Steps 1 through 5.

According to Method 5, continue with Step 6 as follows:

(6) Using the schedule constructed using infinite resource capacity S₀ and the corresponding the unit duration D₀, compute a using
   a=D₀=9036
(7) Using two selected schedules Sₓ and S_{y}, and the corresponding unit durations Dₓ and D_{z}, compute k using

$$k = \frac{( {D}_{x} - a )}{( {D}_{y} - a )} = \frac{( 16114 - 9036 )}{( 11234 - 9036 )} = 3.2202$$
(8) Using the same two selected schedules Sₓ and S_{y}, and the corresponding total resource quantities Tₓ and T_{y}, compute c using

$$c = \frac{( k \cdot {T}_{x} - {T}_{y} )}{( k - 1 )} = \frac{( 3.2202 \cdot 39 - 72 )}{( 3.2202 - 1 )} = 24.1365$$
(9) Using one of the selected schedules Sₓ, and the corresponding unit duration Dₓ and resource quantity Tₓ, compute b using
   b=(D−a)·(Tₓ−c)=(16114−9036)·(39−24.1365)=105204
(10) End

Returning to Method 3, skip Step 2, continue with Step 3 and use Method 3.2 to determine the quantity of Category 2 resources required per unit. According to Method 3.2 determine the quantity of Category 2 resources required per unit as a result of performing the following step. Given a target unit duration D, determine quantity of dedicated resources Q₂ required as follows:
(1) Compute a parametric estimate for quantity of dedicated Category 2 resources Q₂ using the inverse formulation of the Parametric Model of Unit Duration

$$\begin{matrix}{Q}_{2} = \frac{( D - a ) \cdot c + b}{( D - a )} \\ = \frac{( 14400 - 9036 ) \cdot 24.1365 + 105204}{( 14400 - 9036 )} \\ = 43.7495\end{matrix}$$

Finally, in answer to the initial questions:
What unit duration must be achieved to support this rate?
What quantity of Category 2 resources is required to achieve this unit duration?
   The required unit duration is 16 days, and the required quantity of Category 2 resources is 44 (rounding 43.7495 up to the next higher integer). Specific quantities of the constituent Category 2 resources can be determined by interpolation within the Parametric Series of Resource Vectors.

### Example 2

### Suppose that Category 1 Resources are Constrained at Quantity 3, and that Category 2 Resources are Constrained at Quantity 39 Per Unit (and in Sufficient Total Quantity 117 to Support 3 Concurrent Production Units)

What production interval (or equivalently production rate) can be achieved with these resources?
What level of utilization will be achieved with the provided Category 1 and Category 2 resources?

Beginning with Method 1 use Method 2, and then Method 2.3 to determine the minimum feasible unit duration. According to Method 2.3 determine the minimum feasible unit duration as a result of performing the following steps. Given fixed or target values for the quantity of dedicated Category 1 resources Q1 and unit duration D, determine the minimum acceptable production interval I using the following steps:
(1) If the value for unit duration D is known, go to step 3.
(2) Use Method 3 to determine minimum feasible unit duration D, using the quantity of dedicated Category 2 resources Q₂ provided to complete one production unit
(3) Compute the maximum degree of concurrency using
   K=Q₁
(4) Compute the minimum acceptable production interval I using

$$I = ⌈ \frac{D}{K} ⌉$$
(5) End

According to Step 2 of Method 2.3, use Method 3 to determine the minimum feasible unit duration. According to Method 3 determine the minimum feasible unit duration as a result of performing the following steps:
(1) Use Method 5 to compute the coefficients a, b, and c of the Parametric Model of Unit Duration
(2) If the objective is to determine the minimum unit duration D that can be achieved with a given quantity of dedicated resources Q₂, use Method 3.1
(3) If the objective is to determine quantity of dedicated resources Q₂ required to achieve a given unit duration D, use Method 3.2
(4) End

Since the coefficients of the Parametric Model of Unit Duration are known from provided background data and the analysis performed in example 1, continue the process with Step 2 of Method 3, where Method 3.1 is used to determine the minimum unit duration. According to Method 3.1 and the background data presented in the previous section, estimate the minimum feasible unit duration as a result of performing the following step. Given a quantity of dedicated resources Q₂, determine the minimum unit duration D that can be achieved.
(1) Compute a parametric estimate for the value for unit duration D using the Parametric Model of Unit Duration:

$$\begin{matrix}D = a + \frac{b}{( {Q}_{2} - c )} \\ = 9036 + \frac{105204}{( 29 - 24.1365 )} \\ = 16114 minutes \\ = 17.90 days\end{matrix}$$

Returning to Method 2.3, determine the minimum interval between successive production units as a result of performing the following steps.
(3) Compute the maximum degree of concurrency using
   K=Q₁=3
(4) Compute the minimum acceptable production interval I using

$$I = ⌈ \frac{D}{K} ⌉ = ⌈ \frac{17.90}{3} ⌉ = 6$$
(5) End

Use Method 4 to determine the effective Category 1 and Category 2 resource utilization, first using Method 4.1 and then Method 4.2. According to Method 4.1, determine the utilization of Category 1 resources as a result of performing the following steps. Determine utilization of dedicated Category 1 resources.
(1) If the quantity of Category 1 resources Q₁ is known go to step 3
(2) Use Method 2 to determine required quantity of Category 1 resources Q₁, given unit duration D and production interval I.
(3) Compute degree of concurrency C using

$$C = \frac{D}{I} = \frac{17.90}{6} = 2.98$$
(4) Compute resource utilization U₁ using

$${U}_{1} = \frac{C}{{Q}_{1}} = \frac{2.98}{3} = 99.47 \%$$
(5) End

According to Method 4.2, determine the utilization of Category 22 resources as a result of performing the following steps. Since quantity, duration, and total work content have been previously determined, Step 6 is effectively the starting point. Determine utilization of dedicated Category 2 resources.
(1) If the unit duration D is known go to step 3
(2) Use Method 3 to determine unit duration D given provided quantity of Category 2 resources Q₂.
(3) If the quantity of Category 2 resources Q₂ is known go to step 5
(4) Use Method 3 to determine quantity of Category 2 resources Q₂ required given target unit duration D.
(5) Use Method 7 to determine total work content T
(6) Compute resource utilization U2 using

$${U}_{2} = \frac{T}{{Q}_{2} \cdot D} = \frac{104021}{39 \cdot 16114} = 16.55 \%$$
(7) End

Finally in answer to the initial questions:
What production interval (or equivalently production rate) can be achieved with these resources?
What level of utilization will be achieved with the Category 1 and Category 2 resources?

A production interval of 6 days between units can be sustained with the provided Category 1 and Category 2 resources. Utilization of Category 1 resources is nearly perfect at 99.47% while utilization of Category 2 resources is only 16.55%. This is largely because a few tasks require a large number of individuals, and staffing to satisfy the requirements of those few tasks creates inefficiency. (See Table 1).

It should be understood, of course, that the foregoing relates to exemplary embodiments of the invention and that modifications may be made without departing from the spirit and scope of the invention as set forth in the following claims.

We claim:

1. A method for production rate and capacity planning, the method comprising:
determining a resource quantity, unit duration, and production interval for Category 1 resourcesa for Category 2 resourcesa for Category 1 and Category 2 resources, wherein Category 1 resources comprise resources that are not shared between production units, which effect concurrency between said production units, which have no effect on said unit duration, and which have no effect on degree of concurrency within said production units;
determining a resource quantity and unit duration for Category 2 resources, wherein Category 2 resources comprise resources that are not shared between said production units, which do not effect said concurrency between said production units, and which effect said unit duration by enabling said concurrency within said production units; and
determining a resource utilization for Category 1 and Category 2 resources.

2. A method for determining the resource quantity, unit duration, and production interval for Category 1 resources, the method comprising:
determining a minimum acceptable quantity of Category 1 resources using at least one of fixed and target values for unit duration and production interval, wherein Category 1 resources comprise resources that are not shared between production units, which effect concurrency between said production units, which have no effect on said unit duration, and which have no effect on degree of concurrency within said production units;
determining a maximum acceptable unit duration using at least one of fixed and target values for quantity of Category 1 resources and production interval; and
determining a minimum acceptable production interval using at least one of fixed and target values for quantity of Category 1 resources and unit duration.

3. A method for determining the resource quantity and unit duration for Category 2 resources, the method comprising:
determining coefficients of a Parametric Model of Unit Duration;
determining a minimum unit duration that can be achieved with a given quantity of dedicated resources; and
determining a quantity of dedicated resources required to achieve a given unit duration, wherein Category 2 resources comprise resources that are not shared between said production units, which do not effect said concurrency between said production units, and which effect said unit duration by enabling said concurrency within said production units.

4. A method for determining the resource utilization, the method comprising:
determining a utilization of Category 1 resources using known quantities for at least one of unit duration, production interval, and quantity of dedicated resources, wherein Category 1 resources comprise resources that are not shared between production units, which effect concurrency between said production units, which have no effect on said unit duration, and which have no effect on degree of concurrency within said production units; and
determining a utilization of Category 2 resources using known quantities for at least one of unit duration and quantity of dedicated resources, wherein Category 2 resources comprise resources that are not shared between said production units, which do not effect said concurrency between said production units, and which effect said unit duration by enabling said concurrency within said production units.

5. The method of claim 2 wherein the step of determining the minimum acceptable quantity of Category 1 resources using at least one of fixed and target values for unit duration and production interval comprises:
determining a minimum feasible unit duration using a quantity of Category 2 resources which are available to complete one production unit;
computing a maximum degree of concurrency that will occur during the course of production; and
computing a required quantity of dedicated Category 1 resources.

6. The method of claim 2 wherein the step of determining the maximum acceptable unit duration using at least one of fixed and target values for quantity of Category 1 resources and production interval comprises:
computing a maximum acceptable degree of concurrency;
computing a maximum acceptable unit duration; and
determining a minimum quantity of Category 2 resources required to complete one production unit in duration.

7. The method of claim 2 wherein the step of determining the minimum acceptable production interval using at least one of fixed and target values for quantity of Category 1 resources and unit duration comprises:
determining a minimum feasible unit duration using a quantity of Category 2 resources provided to complete one production unit;
computing a maximum degree of concurrency; and
computing a minimum acceptable production interval.

8. The method of claim 3 wherein the step of determining coefficients of the Parametric Model of Unit Duration comprises:
constructing a parametric series of resource vectors;
recording a total resource quantity for each member of the parametric series of resource vectors;
constructing a single-unit schedule for each member of the parametric series of resource vectors;
recording a unit duration for each member of the parametric series of single-unit schedules;
constructing an additional schedule where the resource capacity provided is infinite; and
computing coefficients of the Parametric Model of Unit Duration using the constructed schedules.

9. The method of claim 3 wherein the step of determining the minimum unit duration that can be achieved with a given quantity of dedicated resources comprises:
computing a parametric estimate for the value of unit duration using the Parametric Model of Unit Duration;
constructing a proportional resource vector;
constructing a working resource vector using the proportional resource vector;
modifying elements of the working resource vector to satisfy minimum resource requirements; and
constructing a schedule using the modified working resource vector to determine a constructive estimate of unit duration.

10. The method of claim 3 wherein the step of determining the quantity of dedicated resources required to achieve a given unit duration comprises:
computing a parametric estimate for quantity of Category 2 resources using the inverse formulation of the Parametric Model of Unit Duration;
constructing a proportional resource vector;
constructing a working resource vector using the proportional resource vector;
modifying elements of the working resource vector to satisfy minimum resource requirements;
constructing a schedule using the modified working resource vector to determine a constructive estimate of unit duration; and
modifying the quantity of resources in the working resource vector, and iterating the constructive estimate of unit duration.

11. The method of claim 4 wherein the step of determining the utilization of Category 1 resources using known quantities for at least one of unit duration, production interval, and quantity of dedicated resources comprises:
determining a required quantity of Category 1 resources using known quantities of unit duration and production interval;
computing a degree of concurrency; and
computing a resource utilization.

12. The method of claim 4 wherein the step of determining the utilization of Category 2 resources using known quantities for at least one of unit duration and quantity of dedicated resources comprises:
determining a unit duration using a provided quantity of Category 2 resources;
determining a required quantity of Category 2 resources to achieve a target unit duration;
determining a total work content; and
computing a resource utilization.

13. The method of claim 8 wherein the step of constructing the parametric series of resource vectors comprises:
constructing a work content vector and determining total work content;
constructing a proportional work content vector;
constructing a proportional resource vector; and
constructing a quantized series resource vector.

14. The method of claim 13 wherein the step of constructing thethe work content vector and determining total work content comprises:
documenting resources required to perform each task required to complete one production unit;
dividing documented resources into resource categories;
tabulating aa quantity of required resources, in each of the resource categories, for each task required to complete said one production unit;
tabulating a task duration for each task required to complete said one production unit;
constructing a work content vector; and
computing a total work content.

15. The method of claim 2 wherein the step of determining the minimum acceptable quantity of Category 1 resources using said at least one fixed and target values for unit duration and production interval comprises utilizing the formula
$$C = \frac{D}{I} ,$$
the step of determining said maximum acceptable unit duration using said at least one fixed and target values for quantity of Category 1 resources and production interval comprises utilizing the formula D=C·I, and the step of determining said minimum acceptable production interval using said at least one of said fixed and target values for quantity of Category 1 resources and unit duration comprises utilizing the formula
$$I = \frac{D}{C} ,$$
wherein D represents unit duration, I represents production interval, and C represents degree of concurrency.

16. The method of claim 3 wherein the step of determining said minimum unit duration that can be achieved with said given quantity of dedicated resources comprises utilizing the formula
$$D = a + \frac{b}{( {Q}_{2} - c )}$$
and the step of determining said quantity of dedicated resources required to achieve said given unit duration comprises utilizing the formula
$${Q}_{2} = \frac{( D - a ) \cdot c + b}{( D - a )} ,$$
wherein Q₂ represents Category 2 resources, D represents unit duration, and the coefficients a, b, and c are determined by constructing a parametric series of resource vectors, by recording a total resource quantity for each member of the parametric series of resource vectors, by constructing a single-unit schedule for each member of the parametric series of resource vectors, by recording a unit duration for each member of the parametric series of single-unit schedules, by constructing one additional schedule where the resource capacity provided is infinite, and by computing coefficients of the Parametric Model of Unit Duration using the constructed schedules.

17. The method of claim 1 wherein said method is utilized for production rate and capacity planning in at least one of manufacturing, maintenance, supply, transportation, and training.

18. The method of claim 1 wherein said method is utilized for planning organizational capacity in capital, staffing, equipment, and facilities.

19. The method of claim 1 wherein said method is utilized for planning at least one of enterprise investment, acquisition, divestiture, contracting, sub-contracting, joint ventures, partnership, hiring, and layoff.

20. The method of claim 1 wherein said method is utilized in mathematical analysis to make decisions to at least one of increase and decrease resource capacity.

21. The method of claim 1 wherein said method is utilized in mathematical analysis to make decisions to at least one of increase and decrease production rate.

22. The method of claim 1 wherein said method is utilized in mathematical analysis to at least one of estimate and determine the cost of production operations, and corresponding cost of goods or services.

23. The method of claim 1 wherein said method is utilized in mathematical analysis to at least one of make decisions to increase and decrease price of goods and services.

24. The method of claim 2 wherein said method is utilized to plan sales targets, production targets, and overall manufacturing capacity based upon market demand and opportunity.

25. The method of claim 2 wherein said method is utilized to determine the quantity of Category 1 required to support target sales and production rates.

26. The method of claim 2 wherein said method is utilized to determine the maximum sales and production rates that can be supported with existing Category 1 resources.

27. The method of claim 3 wherein said method is utilized to plan facility usage, space occupancy, and production flows.

28. The method of claim 3 wherein said method is utilized to determine the quantity of Category 1 resources required to support target unit duration.

29. The method of claim 3 wherein said method is utilized to determine the minimum unit duration that can be achieved using available Category 2 resources.

30. The method of claim 4 wherein said method is utilized to plan allocation and use of Category 1 and Category 2 resources based upon target production rates and durations and estimated revenue, cost of operations, resource utilization, and resulting profitability.
